(19) United States
(12) Patent Application Publication
(10) Pub. No.: US 2026/0147244 A1
(43) Pub. Date: May 28, 2026

(54) LIQUID CRYSTAL PANEL AND DISPLAY DEVICE

(71) Applicant: Sharp Display Technology Corporation, Kameyama City (JP)

(72) Inventor: Ryo YONEBAYASHI, Kameyama City (JP)

(21) Appl. No.: 19/398,256

(22) Filed: Nov. 24, 2025

(30) Foreign Application Priority Data
Nov. 25, 2024 (JP) 2024-204620

(51) Int. Cl. G02F 1/1343; G02F 1/1368

(52) U.S. Cl. CPC G02F 1/134309; G02F 1/1368

(57) ABSTRACT

A liquid crystal panel has a display region and a frame region and includes first and second substrates and a liquid crystal layer. The first or second substrate includes a frame line. The first substrate includes first and second electrodes electrically connected to the frame line, and a switching element. First and second input signals respectively input to the first and second electrodes undergo a repeated cycle of periods in the following order: a first period in which the signal is set more positive than a reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential.

### CROSS-REFERENCE TO RELATED APPLICATIONS

The present application claims priority under 35 U.S.C. § 119 to Japanese Patent Application No. 2024-204620 filed on Nov. 25, 2024, the contents of which are incorporated herein by reference in their entirety.

### BACKGROUND OF THE INVENTION

### Field of the Invention

The following disclosure relates to liquid crystal panels and display devices.

### Description of Related Art

JP 2008-165174 A discloses a technique related to a liquid crystal panel, which is an array substrate for a lateral electric field type liquid crystal display device. The device includes: first and second gate lines formed on a substrate including first and second pixel regions; a common line formed parallel to and spaced apart from the first gate line; a data line intersecting the first and second gate lines to define the first and second pixel regions; a first thin film transistor connected to the first gate line and the data line, and disposed in the first pixel region; a second thin film transistor connected to the second gate line and the data line, and disposed in the second pixel region; a repair pattern extending from the first thin film transistor toward the second pixel region; a plurality of pixel electrodes disposed in the first pixel region and connected to the first thin film transistor; a plurality of common electrodes disposed in the first pixel region, connected to the common line, and alternately arranged with the pixel electrodes; and a first pixel pattern disposed in the second pixel region, connected to the second thin film transistor, and overlapping the repair pattern.

### BRIEF SUMMARY OF THE INVENTION

One suggested three-dimensional display method uses a display device in which two liquid crystal panels are stacked. In the method, the back surface side liquid crystal panel (image display panel) alternately displays images for the left and right eyes, while the observation surface side liquid crystal panel controls the polarization states of the images. Using polarized glasses, the user can perceive separate images for the left and right eyes. The observation surface side liquid crystal panel functions as what is commonly known as an active retarder, and is therefore referred to also as an active retarder panel. Such a display device that delivers separate images to the left and right eyes in a time-sequential manner to create a sense of depth is referred to also as an active retarder-type three-dimensional display device.

FIG. 30 is a schematic plan view showing the structure of a conventional active retarder panel. FIG. 31 is a diagram providing a visual representation of charging delay in the first to fourth segments in the conventional active retarder panel shown in FIG. 30. The active retarder panel includes, for example, a liquid crystal layer and a pair of electrodes (pixel electrode and common electrode) that applies voltage to the liquid crystal layer. The pixel electrode and the common electrode are each formed of a relatively highly resistant transparent electrode. The pixel electrode (segment electrode) or the common electrode (COM electrode) in an active retarder panel 11R shown in FIG. 30 is divided, for example, into a fraction of the size of a display region 1AA, through depending on the number of divisions. Specifically, as shown in FIG. 30, the pixel electrode or the common electrode is divided into a first segment 1S, a second segment 2S, a third segment 3S, and a fourth segment 4S.

Frame lines 100NL, which are low-resistance metal lines, can be arranged in a frame region 1NA of the active retarder panel 11R. This readily supplies signals from the frame lines 100NL to the transparent electrodes (pixel electrode and common electrode) near the outer periphery within the display region 1AA. However, at locations far from the frame lines 100NL (i.e., near the center of the display region 1AA), signals are input through the high-resistance transparent electrodes (pixel electrode and common electrode), which tends to cause signal delays.

Additionally, when the number of pixel divisions is three or more, at least one pixel is connected to the peripheral frame lines 100NL only along its two sides. This structure leads to more significant signal delays. For example, when the number of pixel divisions is four (pixel division into four segments), as shown in FIG. 30, the first segment 1S and the fourth segment 4S receive signals from three sides, while the second segment 2S and the third segment 3S receive signals only from two sides.

Since the central portions of the first segment 1S and the fourth segment 4S are close to the frame lines 100NL, signal delays tend not to occur in the central portions of the first segment 1S and the fourth segment 4S. However, since the central portions of the second segment 2S and the third segment 3S are far from the frame lines 100NL, signal delays tend to occur in the central portions of the second segment 2S and the third segment 3S. As a result, as shown in FIG. 31, greater charging delay occurs in the second segment 2S and the third segment 3S than in the first segment 1S and the fourth segment 4S.

In this manner, in the active retarder panel 11R, signal delays may occur, such as a delay in signal input to the pixel electrode and a prolonged time for a potential affected by noise from the common electrode to return to its original level.

JP 2008-165174 A does not disclose a liquid crystal panel in which signal delays are reduced or prevented.

In response to the above issues, the present invention aims to provide a liquid crystal panel in which signal delays are reduced or prevented, and a display device including the liquid crystal panel.
(1) One embodiment of the present invention is directed to a liquid crystal panel with a display region and a frame region surrounding the display region, the liquid crystal panel including: a first substrate; a second substrate facing the first substrate; and a liquid crystal layer arranged between the first substrate and the second substrate, wherein the first substrate or the second substrate includes a frame line arranged in the frame region, the first substrate includes, within the display region, a first electrode and a second electrode electrically connected to the frame line, and a switching element configured to control electrical connection between the first electrode and the second electrode, a first input signal is input to the first electrode, and a second input signal is input to the second electrode, the first input signal and the second input signal each undergo a repeated cycle of periods in the following order: a first period in which the signal is set more positive than a reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential, the first period, the second period, the third period, and the fourth period of the first input signal overlap with and begin at timings earlier than the first period, the second period, the third period, and the fourth period of the second input signal, respectively, and the first electrode is electrically connected to the second electrode via the switching element in a period from a beginning of the second period of the second input signal to an end of the second period of the first input signal and in a period from a beginning of the fourth period of the second input signal to an end of the fourth period of the first input signal.
(2) In an embodiment of the present invention, the liquid crystal panel includes the structure (1), and the first electrode is electrically connected to the second electrode via the switching element in a period from a beginning of the first period of the second input signal to an end of the first period of the first input signal and in a period from a beginning of the third period of the second input signal to an end of the third period of the first input signal.
(3) In an embodiment of the present invention, the liquid crystal panel includes the structure (1) or (2), and a timing at which the first electrode is electrically connected to the second electrode via the switching element is later than a timing at which the first period of the second input signal begins.
(4) In an embodiment of the present invention, the liquid crystal panel includes the structure (1), and the first electrode is not electrically connected to the second electrode in a period from a beginning of the first period of the second input signal to an end of the first period of the first input signal and in a period from a beginning of the third period of the second input signal to an end of the third period of the first input signal.
(5) In an embodiment of the present invention, the liquid crystal panel includes the structure (1), (2), (3), or (4), and the first electrode and the second electrode are arranged along a first direction of the liquid crystal panel and extend along a second direction perpendicular to the first direction.
(6) In an embodiment of the present invention, the liquid crystal panel includes the structure (5), the liquid crystal panel includes a plurality of switching elements, each being identical to the switching element, and the plurality of switching elements are arranged from one end portion to an other end portion of the liquid crystal panel in the second direction.
(7) In an embodiment of the present invention, the liquid crystal panel includes the structure (5), the liquid crystal panel includes one or more switching elements, each being identical to the switching element, and the one or more switching elements are arranged in a central portion of the liquid crystal panel in the second direction, and are not arranged in a frame-adjacent portion of the liquid crystal panel in the second direction.
(8) In an embodiment of the present invention, the liquid crystal panel includes the structure (5), the liquid crystal panel includes a plurality of switching elements, each being identical to the switching element, and the plurality of switching elements include a central portion switching element arranged in a central portion of the liquid crystal panel in the second direction and a frame-adjacent portion switching element arranged in a frame-adjacent portion of the liquid crystal panel in the second direction.
(9) In an embodiment of the present invention, the liquid crystal panel includes the structure (8), in the second period, the first input signal and the second input signal are temporarily set more negative than the reference potential and subsequently set to the reference potential, the first electrode connected to the central portion switching element and the second electrode connected to the central portion switching element are electrically connected via the central portion switching element at a timing at which the second period of the second input signal begins, and the first electrode connected to the frame-adjacent portion switching element and the second electrode connected to the frame-adjacent portion switching element are electrically connected via the frame-adjacent portion switching element later than the timing at which the second period of the second input signal begins.
(10) In an embodiment of the present invention, the liquid crystal panel includes the structure (1), (2), (3), (4), (5), (6), (7), (8), or (9), and the switching element is controlled by a control signal that is different from the first input signal and the second input signal.
(11) In an embodiment of the present invention, the liquid crystal panel includes the structure (1), (2), (3), (4), (5), (6), (7), (8), (9), or (10), and in a plan view, an edge of the first electrode facing the frame region is longer than an edge of the second electrode facing the frame region.
(12) Another embodiment of the present invention is directed to a display device including: the liquid crystal panel including the structure (1), (2), (3), (4), (5), (6), (7), (8), (9), (10), or (11); an image display panel disposed adjacent to a back surface of the liquid crystal panel; and a backlight disposed adjacent to a back surface of the image display panel.

The present invention can provide a liquid crystal panel in which signal delays are reduced or prevented, and a display device including the liquid crystal panel.

### BRIEF DESCRIPTION OF THE DRAWINGS

FIG. 1 is a schematic cross-sectional view of a display device of Embodiment 1.

FIG. 2 is a schematic plan view of a liquid crystal panel of Embodiment 1.

FIG. 3 is an enlarged schematic plan view of the region 11A in FIG. 2.

FIG. 4 is a schematic cross-sectional view taken along line A1-A2 in FIG. 3.

FIG. 5 is a timing diagram of a first input signal input to a first pixel electrode, a second input signal input to a second pixel electrode, and a first control signal input to a first switching element in the liquid crystal panel of Embodiment 1.

FIG. 6 is an equivalent circuit diagram of the liquid crystal panel of Embodiment 1.

FIG. 7 is an enlarged schematic plan view of the region 11B in FIG. 2.

FIG. 8 is a schematic cross-sectional view taken along line B1-B2 in FIG. 7.

FIG. 9 is a timing diagram of a second input signal input to a second pixel electrode in the liquid crystal panel of Embodiment 1, a third input signal input to a third pixel electrode, and a second control signal input to a second switching element.

FIG. 10 is an enlarged schematic plan view of the region 11C in FIG. 2.

FIG. 11 is a schematic cross-sectional view taken along line C1-C2 in FIG. 10.

FIG. 12 is a timing diagram of a third input signal input to a third pixel electrode in the liquid crystal panel of Embodiment 1, a fourth input signal input to a fourth pixel electrode, and a third control signal input to a third switching element.

FIG. 13 is a timing diagram of first, second, third, and fourth input signals input to first, second, third, and fourth pixel electrodes in the liquid crystal panel of Embodiment 1.

FIG. 14 is a timing diagram of the time-dependent potential changes of the first pixel electrode and the second pixel electrode in the liquid crystal panel of Embodiment 1, and the first control signal.

FIG. 15 is a timing diagram of the time-dependent potential changes of the first pixel electrode and the second pixel electrode in a liquid crystal panel of Embodiment 2, and the first control signal.

FIG. 16 is a timing diagram of a first input signal input to a first pixel electrode in the liquid crystal panel of Embodiment 1, a second input signal input to a second pixel electrode, and a first control signal input to a first switching element.

FIG. 17 is a timing diagram of a first input signal input to a first pixel electrode in a liquid crystal panel of Embodiment 3, a second input signal input to a second pixel electrode, and a first control signal input to a first switching element.

FIG. 18 is a schematic plan view of the liquid crystal panel of Embodiment 1.

FIG. 19 is a timing diagram of the time-dependent potential change of the second pixel electrode in the liquid crystal panel of Embodiment 1 when an overshoot is applied to the second input signal input to the second pixel electrode.

FIG. 20 is a schematic plan view illustrating a case where the first pixel electrode and the second pixel electrode are connected by the first switching element across the entire lateral region of the liquid crystal panel of Embodiment 1.

FIG. 21 is a timing diagram of the time-dependent potential changes of the first pixel electrode and the second pixel electrode in a frame-adjacent portion of a liquid crystal panel having the structure shown in FIG. 20.

FIG. 22 is a schematic plan view of a liquid crystal panel of Embodiment 4.

FIG. 23 is a timing diagram of the time-dependent potential changes of the first pixel electrode and the second pixel electrode in a frame-adjacent portion of the liquid crystal panel of Embodiment 4.

FIG. 24 is a schematic plan view of a liquid crystal panel of Embodiment 5.

FIG. 25 is a schematic cross-sectional view of a central portion of the liquid crystal panel of Embodiment 5.

FIG. 26 is a schematic cross-sectional view of a frame-adjacent portion of the liquid crystal panel of Embodiment 5.

FIG. 27 is an equivalent circuit diagram of the liquid crystal panel of Embodiment 5.

FIG. 28 is a timing diagram of the time-dependent potential changes of the second pixel electrode in a liquid crystal panel central portion and a frame-adjacent portion of the liquid crystal panel of Embodiment 5.

FIG. 29 is a timing diagram of the time-dependent potential changes of the first pixel electrode and the second pixel electrode in liquid crystal panels of Example 1 and Comparative Example 1, and a first control signal.

FIG. 30 is a schematic plan view showing the structure of a conventional active retarder panel.

FIG. 31 is a diagram providing a visual representation of charging delay in the first to fourth segments in the conventional active retarder panel shown in FIG. 30.

### DETAILED DESCRIPTION OF THE INVENTION

Hereinafter, embodiments of the present invention are described. The present invention is not limited to the contents of the following embodiments. The design may be modified as appropriate within the range satisfying the configuration of the present invention. In the following description, components having the same or similar functions in different drawings are commonly provided with the same reference sign so as to appropriately avoid repetition of description. The embodiments in the present invention may be combined as appropriate without departing from the gist of the present invention.

Herein, the “observation surface side” means the side closer to the screen (display surface) of the liquid crystal panel, and the “back surface side” means the side farther from the screen (display surface) of the liquid crystal panel.

### Embodiment 1

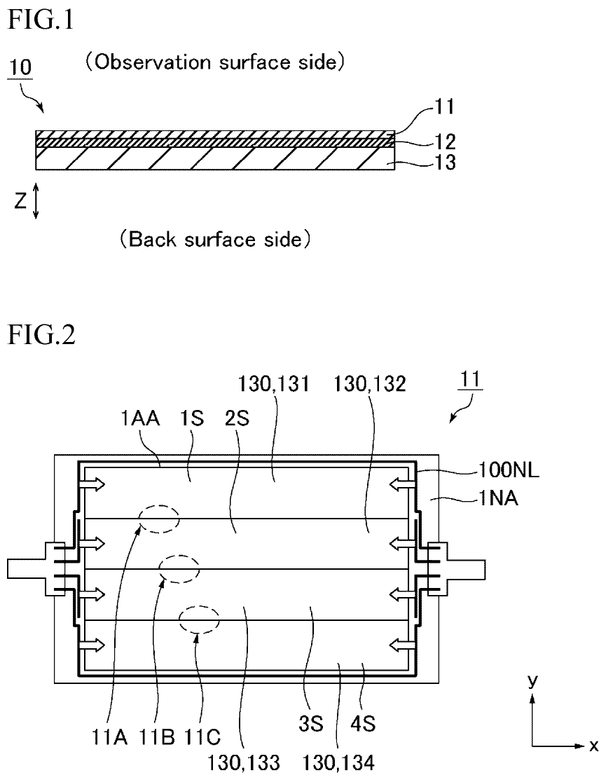

FIG. 1 is a schematic cross-sectional view of a display device of Embodiment 1. Embodiment 1 is described based on FIG. 1 to FIG. 13. The present embodiment shows a display device 10 as an example. Some of the drawings show the X-axis, Y-axis, and Z-axis, and the directions of these axes are depicted to match the directions indicated in the drawings.

A display device 10 of the present embodiment is a type of 3D image display device which enables the user to see 3D images (three-dimensional images) and employs an active retarder method. The display device 10 includes, as shown in FIG. 1, a liquid crystal panel 11, an image display panel 12 on the back surface of the liquid crystal panel 11, and a backlight 13 on the back surface of the image display panel 12.

The image display panel 12 functions to display images.

The backlight 13 is an external light source that emits light to be utilized in display toward the image display panel 12. The backlight 13 includes a light source (e.g., LED) that emits white-colored light (white light), an optical member that applies optical effects to light emitted from the light source to convert the light into planar light.

The liquid crystal panel 11 functions as a modulator that converts linearly polarized light emitted from the image display panel 12 into circularly polarized light. Specifically, the liquid crystal panel 11 can switch between right-handed circularly polarized light and left-handed circularly polarized light in synchronization with the image display panel 12 which alternately displays an image for the right eye and an image for the left eye. In other words, the liquid crystal panel 11 functions as an active retarder panel.

The display device 10 of the present embodiment is used in combination with circularly polarized glasses incorporating circularly polarized light films with opposite handedness for the right and left lenses. By wearing the circularly polarized glasses and viewing the display device 10, the user can perceive 3D images. In this manner, since the liquid crystal panel 11 is driven at high speed in synchronization with the display on the image display panel 12, signal delays are desired to be reduced or prevented in the liquid crystal panel 11.

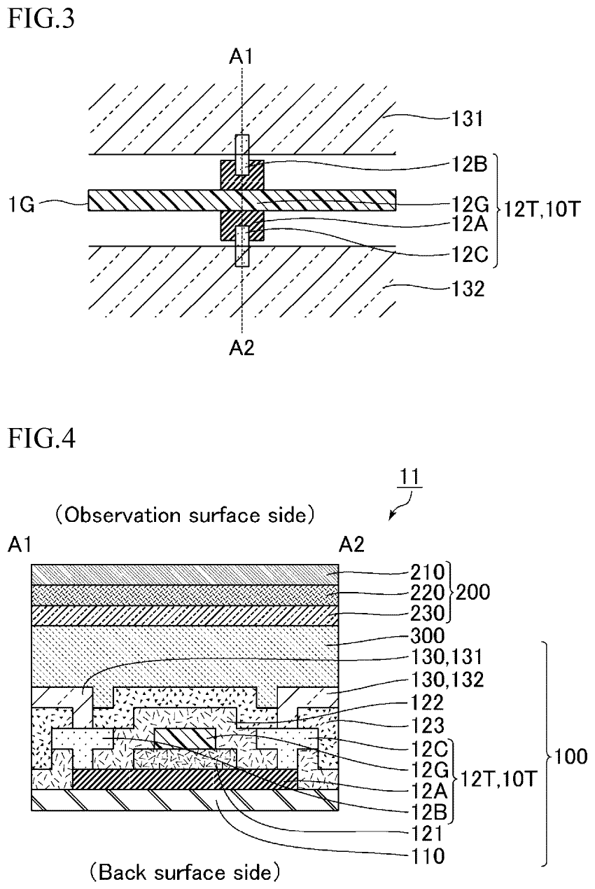

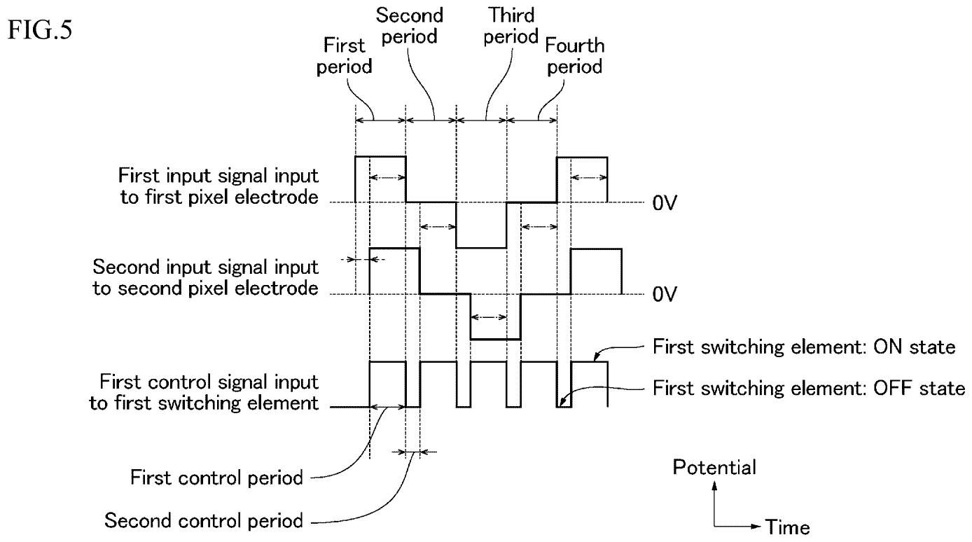

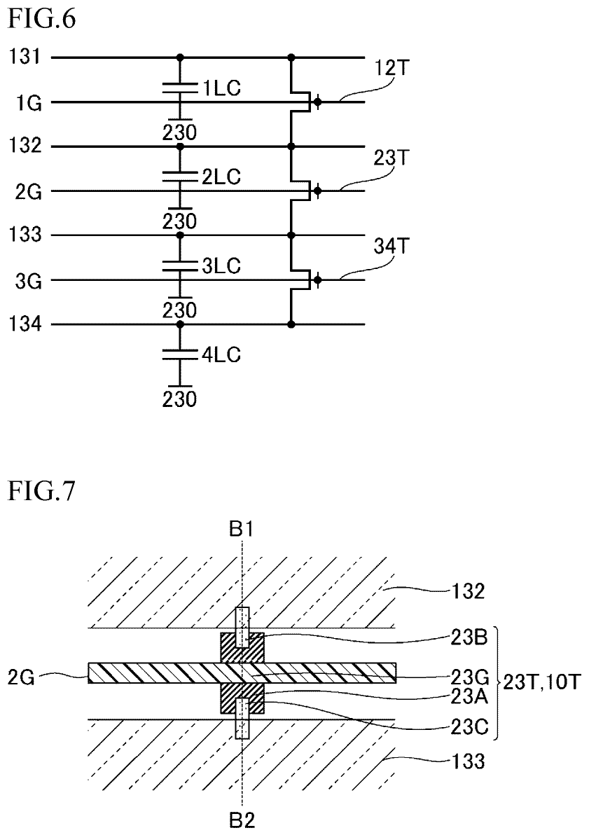

FIG. 2 is a schematic plan view of a liquid crystal panel of Embodiment 1. FIG. 3 is an enlarged schematic plan view of the region 11A in FIG. 2. FIG. 4 is a schematic cross-sectional view taken along line A1-A2 in FIG. 3. FIG. 5 is a timing diagram of a first input signal input to a first pixel electrode, a second input signal input to a second pixel electrode, and a first control signal input to a first switching element in the liquid crystal panel of Embodiment 1. FIG. 6 is an equivalent circuit diagram of the liquid crystal panel of Embodiment 1.

As shown in FIG. 2 to FIG. 4, the liquid crystal panel 11 of the present embodiment has a display region 1AA and a frame region 1NA surrounding the display region 1AA, and includes a first substrate 100, a second substrate 200 facing the first substrate 100, and a liquid crystal layer 300 arranged between the first substrate 100 and the second substrate 200. The first substrate 100 or the second substrate 200 includes frame lines 100NL arranged in the frame region 1NA. The first substrate 100 includes, within the display region 1AA, a first pixel electrode 131 as the first electrode and a second pixel electrode 132 as the second electrode which are electrically connected to the frame lines 100NL, and a switching element 12T (hereinafter, referred to also as “first switching element 12T”) which controls the electrical connection between the first pixel electrode 131 and the second pixel electrode 132. This embodiment enables electrical connection between the first pixel electrode 131 and the second pixel electrode 132 via the switching element 12T when the switching element 12T is switched to the ON state. As a result, the first pixel electrode 131 as well as the frame lines 100NL can be signal input paths to the second pixel electrode 132, thereby reducing or preventing delays in signal input to the second pixel electrode 132. Hereinbelow, the first pixel electrode 131 and the second pixel electrode 132 may also be referred to collectively as “pixel electrodes 130”.

Also, as shown in FIG. 5, a first input signal is input to the first pixel electrode 131, and a second input signal is input to the second pixel electrode 132. The first input signal and the second input signal each undergo a repeated cycle of periods in the following order: a first period in which the signal is set more positive than the reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. The first period, the second period, the third period, and the fourth period of the first input signal overlap with and begin at timings earlier than the first period, the second period, the third period, and the fourth period of the second input signal, respectively. The first pixel electrode 131 is electrically connected to the second pixel electrode 132 via the switching element 12T in the period from the beginning of the second period of the second input signal to the end of the second period of the first input signal and in the period from the beginning of the fourth period of the second input signal to the end of the fourth period of the first input signal. This embodiment can achieve the following effect.

In the periods indicated by the dashed and dotted line arrows in FIG. 5, both of the first pixel electrode 131 and the second pixel electrode 132 are set to potentials different from the reference potential or both of the electrodes are set to the reference potential. Meanwhile, in the periods indicated by the dashed line arrows, one of the first pixel electrode 131 and the second pixel electrode 132 is set to a potential different from the reference potential, and the other is set to the reference potential. In the present embodiment, in the periods in which both of the electrodes are set to the reference potential, i.e., in the period from the beginning of the second period of the second input signal to the end of the second period of the first input signal and in the period from the beginning of the fourth period of the second input signal to the end of the fourth period of the first input signal, the first pixel electrode 131 is electrically connected to the second pixel electrode 132 via the switching element 12T (i.e., the switching element 12T is switched to the ON state). In this state, the signal input paths to the second pixel electrode 132 in FIG. 2 include the charged first pixel electrode 131 as well as the frame lines 100NL (specifically, the frame lines 100NL along the lateral sides of the liquid crystal panel 11), which enables effective reduction of signal delays to the second pixel electrode 132. As described above, in the present embodiment, two electrodes (preferably, adjacent electrodes) are connected via a switching element at an appropriate timing to use an already charged electrode as a conductive line, further reducing signal delays.

When the first period, the second period, the third period, and the fourth period of the first input signal begin simultaneously with the first period, the second period, the third period, and the fourth period of the second input signal, respectively, the phase of the first input signal and the phase of the second input signal match. When the first period, the second period, the third period, and the fourth period of the first input signal begin at different times from the first period, the second period, the third period, and the fourth period of the second input signal, respectively, the phase of the first input signal and the phase of the second input signal differ. When the first period, the second period, the third period, and the fourth period of the first input signal begin at timings earlier than the first period, the second period, the third period, and the fourth period of the second input signal, respectively, the phase of the first input signal leads the phase of the second input signal.

In JP 2008-165174 A, in the array substrate for a liquid crystal display device, the pixel electrode of a defective sub-pixel and the pixel electrode of a sub-pixel vertically adjacent to the defective sub-pixel are connected by melting. As a result, the same signal is input to the defective sub-pixel and the adjacent sub-pixel. Therefore, in the array substrate for a liquid crystal display device in JP 2008-165174 A, exactly the same signal is input to the vertically adjacent two pixels at the same timing. In other words, the configuration of JP 2008-165174 A in which the phases of the signals input to the two sub-pixels are the same is different from the configuration of the present embodiment in which the phase of the input signal to the first pixel electrode 131 and the phase of the input signal to the second pixel electrode 132 differ.

Hereinbelow, the liquid crystal panel of the present embodiment is described in detail below.

As shown in FIG. 2, the liquid crystal panel 11 of the present embodiment has the display region 1AA and the frame region 1NA surrounding the display region 1AA. The display region 1AA may be any region in which the phase difference is controllable. The display region 1AA is a region in which the first pixel electrode 131 and the second pixel electrode 132 are arranged. In the display region 1AA, the alignment of the liquid crystal molecules is changed in response to the magnitude of the voltage applied to the liquid crystal layer 300, so that the phase difference of the liquid crystal layer 300 is controlled.

As shown in FIG. 4, the liquid crystal panel 11 of the present embodiment includes the first substrate 100, the second substrate 200 facing the first substrate 100, and the liquid crystal layer 300 arranged between the first substrate 100 and the second substrate 200. The present embodiment is described based on an example in which the first substrate 100, the liquid crystal layer 300, and the second substrate 200 are arranged in this order from the back surface side toward the observation surface side. However, the second substrate 200, the liquid crystal layer 300, and the first substrate 100 may be arranged in this order from the back surface side toward the observation surface side.

As shown in FIG. 2, the first substrate 100 or the second substrate 200 includes the frame lines 100NL arranged in the frame region 1NA. The frame lines 100NL may be any conductive lines. The frame lines 100NL are electrically connected to the first pixel electrode 131 and the second pixel electrode 132 in the frame region 1NA. The frame lines 100NL are, for example, segment signal lines. Segment signal lines are conductive lines electrically connected to the first pixel electrode 131 and the second pixel electrode 132 to supply segment signals to the pixel electrodes 130.

The frame lines 100NL are preferably arranged in the first substrate 100. This embodiment facilitates connection between the frame lines 100NL to the pixel electrodes 130.

The frame lines 100NL include, for example, a metal such as copper, titanium, aluminum, molybdenum, or tungsten, or an alloy of any of these metals. The frame lines 100NL can be formed by forming a single-or multi-layer film of a metal such as copper, titanium, aluminum, molybdenum, or tungsten, or an alloy of any of these metals by a method such as sputtering, and then patterning the film by a method such as photolithography.

As shown in FIG. 3 and FIG. 4, the first substrate 100 includes, sequentially toward the liquid crystal layer 300: a first support substrate 110; a first semiconductor layer 12A; a first insulating layer 121; a first gate electrode 12G; a second insulating layer 122; a first metal portion 12B connected to the first pixel electrode 131 and the first semiconductor layer 12A and a second metal portion 12C connected to the second pixel electrode 132 and the first semiconductor layer 12A; a third insulating layer 123; and the first pixel electrode 131 and the second pixel electrode 132.

The second substrate 200 includes, sequentially toward the liquid crystal layer 300, a second support substrate 210, an insulating layer 220, and a common electrode 230. The common electrode 230 is electrically connected to a common signal line in the liquid crystal panel 11. The common signal line is, for example, a conductive line that supplies common signals to the common electrode 230.

Alignment films that function to control the alignment of the liquid crystal molecules in the liquid crystal layer 300 are arranged, with one film arranged between the first substrate 100 and the liquid crystal layer 300 and the other film arranged between the second substrate 200 and the liquid crystal layer 300. In a state with no voltage applied where voltage is not applied to the pixel electrodes 130 and the common electrode 230, the liquid crystal molecules in the liquid crystal layer 300 are aligned in a direction substantially perpendicular to the main surfaces of the pair of substrates.

The liquid crystal panel 11 of the present embodiment is a vertical electric field-mode liquid crystal panel in which the first substrate 100 includes the pixel electrodes 130, the second substrate 200 includes the common electrode 230, and a vertical electric field is applied to the liquid crystal layer 300 held between the pixel electrodes 130 and the common electrode 230. More specific examples of the vertical electric field mode include a vertical alignment (VA) mode in which liquid crystal molecules in a liquid crystal layer are aligned in a direction perpendicular to the substrate surfaces in a state with no voltage applied.

Although the common electrode 230 is arranged in the second substrate 200 in the present embodiment, the common electrode 230 may be arranged in the first substrate 100. In this case, the liquid crystal panel 11 is a lateral electric field-mode liquid crystal panel that applies a lateral electric field to the liquid crystal layer 300. Examples of the lateral electric field mode include the fringe field switching (FFS) mode and the in plane switching (IPS) mode in which the liquid crystal molecules in the liquid crystal layer during no voltage application are aligned in a direction parallel to the substrate surfaces.

The liquid crystal panel 11 includes segment signal lines and a common signal line. Segment signals are supplied from a drive circuit outside the panel to the pixel electrodes 130 via the segment signal lines, so that the pixel electrodes 130 are set to the potentials corresponding to the segment signals. Similarly, a common signal is supplied from a drive circuit outside the panel to the common electrode via the common signal line, so that the common electrode is set to the potential corresponding to the common signal. This produces a vertical electric field between the pixel electrodes 130 and the common electrode 230 to control the alignment of the liquid crystal molecules in the liquid crystal layer 300. In the liquid crystal panel 11, in each of the pixels (first segment 1S, second segment 2S, third segment 3S, and fourth segment 4S), the alignment of the liquid crystal molecules changes in response to the magnitude of voltage applied to the liquid crystal layer 300, so that the polarization state of light transmitted through the liquid crystal layer 300 is adjusted.

The liquid crystal panel 11 may include gate lines, source lines, TFTs as switching elements, a source driver, a gate driver, and a controller, in place of the segment signal lines and the common signal line. In this case, the frame lines 100NL are, for example, source lines. The first substrate 100 or the second substrate 200 includes, within the display region 1AA, on a support substrate (first support substrate 110 or second support substrate 210), for example, gate lines extending parallel to one another, and source lines extending parallel to one another in a direction intersecting the gate lines via an insulating film. The gate lines and the source lines as a whole form a grid pattern to define each pixel. For example, at the intersection of a source line and a gate line, a TFT is arranged as a switching element.

The pixel electrodes 130 are each an electrode arranged in a region surrounded by two gate lines adjacent to each other and two source lines adjacent to each other. For example, the pixel electrodes 130 are each set to the potential corresponding to the data signal supplied thereto via the corresponding TFT. The common electrode 230 is an electrode formed on almost the entire surface regardless of the pixel boundaries, excluding specific portions such as the connecting portions between the pixel electrodes 130 and the drain electrodes. A common signal maintained at a constant value is supplied to the common electrode 230, and the common electrode 230 is maintained at a constant potential.

For example, the liquid crystal panel 11 further includes a source driver electrically connected to the source lines, a gate driver electrically connected to the gate lines, and a controller. The gate driver sequentially supplies scanning signals to the gate lines based on the control by the controller. At a timing at which a TFT is switched to a state with voltage applied in response to a scanning signal, the source driver supplies a data signal to the corresponding source line based on the control by the controller. The pixel electrodes 130 are each set to the potential corresponding to the data signal supplied thereto via the corresponding TFT, which generates a vertical electric field between the pixel electrodes 130 and the common electrode 230, thereby controlling the alignment of the liquid crystal molecules in the liquid crystal layer 300. Then, in the liquid crystal panel 11, in each pixel (first segment 1S with the first pixel electrode 131, second segment 2S with the second pixel electrode 132, third segment 3S with a third pixel electrode 133, fourth segment 4S with a fourth pixel electrode 134), the alignment of the liquid crystal molecules changes in response to the magnitude of voltage applied to the liquid crystal layer 300, so that the light transmittance in the liquid crystal layer 300 is adjusted.

Examples of the first support substrate 110 and the second support substrate 210 include insulating substrates such as glass substrates and plastic substrates. Examples of the material for the glass substrates include glass such as float glass and soda-lime glass. Examples of the material for the plastic substrates include plastics such as polyethylene terephthalate, polybutylene terephthalate, polyethersulfone, polycarbonate, and alicyclic polyolefin.

The first insulating layer 121, the second insulating layer 122, the third insulating layer 123, and the insulating layer 220 can each be an inorganic insulating film, an organic insulating film, or a stack of the organic insulating film and the inorganic insulating film. The inorganic insulating film may be, for example, an inorganic film (relative dielectric constant ε=5 to 7) such as a silicon nitride (SiNx) film or a silicon oxide (SiO₂) film, or a stack of such films. The organic insulating film may be, for example, an organic film with a low relative dielectric constant (relative dielectric constant ε=2 to 5) such as a photo-sensitive acrylic resin or a stack of such films.

The liquid crystal layer 300 contains a liquid crystal material. A voltage is applied to the liquid crystal layer 300 to change the alignment of the liquid crystal molecules in the liquid crystal material in response to the applied voltage, thereby controlling the amount of transmitted light.

Liquid crystal molecules may have a positive or negative anisotropy of dielectric constant (Δε) defined by the following formula (L). Liquid crystal molecules having a positive anisotropy of dielectric constant are also referred to as a positive liquid crystal, while liquid crystal molecules having a negative anisotropy of dielectric constant are also referred to as a negative liquid crystal. The long axis direction of a liquid crystal molecule is the slow axis direction. The liquid crystal molecules in a state where no voltage is applied (state with no voltage applied) are homogeneously aligned. The long axis direction of the liquid crystal molecules with no voltage applied is also referred to as the initial alignment direction of the liquid crystal molecules.

Δε=(dielectric constant in long axis direction of liquid crystal molecules)−(dielectric constant in short axis direction of liquid crystal molecules) (L)

The first pixel electrode 131, the second pixel electrode 132, and the common electrode 230 are transparent electrodes. The first pixel electrode 131, the second pixel electrode 132, and the common electrode 230 include, for example, indium tin oxide (ITO), indium zinc oxide (IZO), zinc oxide (ZnO), or tin oxide (SnO), for example. The first pixel electrode 131, the second pixel electrode 132, and the common electrode 230 can be formed, for example, by forming a single-or multi-layer film of a transparent conductive material such as ITO, IZO, ZnO, or SnO, or an alloy of any of these materials by a method such as sputtering, and patterning the film by photolithography. Herein, “transparent” means that the total light transmittance is 90% or higher and 100% or lower. Preferably, the total light transmittance is 95% or higher and 100% or lower. More preferably, the total light transmittance is 98% or higher and 100% or lower. The total light transmittance is determined in accordance with JIS K7361-1.

The first pixel electrode 131 and the second pixel electrode 132 are preferably arranged in the same layer. The first pixel electrode 131 and the second pixel electrode 132 preferably include the same material.

As shown in FIG. 2, the first pixel electrode 131 and the second pixel electrode 132 are arranged along the y-axis direction (vertical direction) corresponding to the first direction of the liquid crystal panel 11, and extend along the x-axis direction (horizontal direction) corresponding to the second direction that is perpendicular to the first direction. This embodiment can more effectively reduce or prevent signal delays in the central portion (region far from the frame lines 100NL) of the second pixel electrode 132 in the second direction.

As shown in FIG. 2, in a plan view, the edge of the first pixel electrode 131 facing the frame region 1NA is preferably longer than the edge of the second pixel electrode 132 facing the frame region 1NA. In such a liquid crystal panel 11, signals from the frame lines 100NL are more easily input to the first pixel electrode 131 than to the second pixel electrode 132. Therefore, at the timing at which the signal input to the second pixel electrode 132 changes, the first pixel electrode 131 can be sufficiently charged. As a result, the already charged first pixel electrode 131 can function as a conductive line, more effectively reducing signal delays to the second pixel electrode 132. The edge of an electrode facing the frame region refers to all edge portions that face the frame region across no other electrode, among the edge portions of the electrode.

A first input signal undergoing an alternately repeated cycle of a positive potential and a negative potential relative to the reference potential is input to the first pixel electrode 131. A second input signal undergoing an alternately repeated cycle of a positive potential and a negative potential relative to the reference potential is input to the second pixel electrode 132. The phase of the first input signal differs from the phase of the second input signal. The reference potential is, for example, 0 V.

The first input signal input to the first pixel electrode 131 suffices as long as the phase thereof differs from the phase of the second input signal input to the second pixel electrode 132. The waveform of the first input signal and the waveform of the second input signal may be the same as or different from each other. The case where the waveforms of the first input signal and the second input signal are different may be, for example, a case where an overshoot is applied to either one of the first input signal and the second input signal. The overshoot is described in detail in Embodiment 4, which is described later.

The waveforms of the first input signal and the second input signal have the shapes shown in FIG. 5, for example. The first input signal undergoes a repeated cycle of periods in the following order: a first period in which the signal is set more positive than the reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. For example, the first pixel electrode 131 undergoes a repeated cycle of application of voltage with a positive polarity, no voltage application, application of voltage with a negative polarity, and no voltage application in this order. In this embodiment, the first pixel electrode 131 is charged repeatedly.

Similarly, the second input signal undergoes a repeated cycle of periods in the following order: a first period in which the signal is set more positive than the reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. For example, the second pixel electrode 132 undergoes a repeated cycle of application of voltage with a positive polarity, no voltage application, application of voltage with a negative polarity, and no voltage application in this order. In this embodiment, the second pixel electrode 132 is charged repeatedly.

The potentials more positive than the reference potential which are set in the first periods of the first and second input signals may differ from each other, but are preferably the same as each other. The potentials more negative than the reference potential which are set in the third periods of the first and second input signals may differ from each other, but are preferably the same as each other. This embodiment can more effectively reduce or prevent signal delays.

The lengths of the first periods of the first input signal and the second input signal are preferably the same. The lengths of the second periods of the first input signal and the second input signal are preferably the same. The lengths of the third periods of the first input signal and the second input signal are preferably the same. The lengths of the fourth periods of the first input signal and the second input signal are preferably the same. This embodiment can more effectively reduce or prevent signal delays.

As shown in FIG. 5, the waveforms of first input signal and the second input signal are the same, and the first period, the second period, the third period, and the fourth period of the first input signal overlap with and begin at timings earlier than the first period, the second period, the third period, and the fourth period of the second input signal, respectively. This embodiment can cause the first pixel electrode 131 to be sufficiently charged and then function as a conductive line, further reducing signal delays to the second pixel electrode 132.

As shown in FIG. 5, preferably, the first pixel electrode 131 is electrically connected to the second pixel electrode 132 via the switching element 12T (i.e., the switching element 12T is in the ON state) in a period from the beginning of the first period of the second input signal to the end of the first period of the first input signal and in a period from the beginning of the third period of the second input signal to the end of the third period of the first input signal. This embodiment can cause the already charged first pixel electrode 131 to function as a conductive line when the second pixel electrode 132 is charged, thereby effectively reducing delays in signal input to the second pixel electrode 132.

At the timing at which the charging of the second pixel electrode 132 begins, the first pixel electrode 131 is more preferably fully charged. This embodiment can cause the already charged first pixel electrode 131 to function as a conductive line to further reduce signal delays to the second pixel electrode 132. The timing at which the charging of an electrode begins refers to a timing at which the potential of the input signal to the electrode is switched from the reference potential to a potential more positive or more negative than the reference potential. Examples of the timing at which the charging of the second pixel electrode 132 begins include a timing at which the first period of the second input signal begins and a timing at which the third period of the second input signal begins.

As shown in FIG. 5, the first pixel electrode 131 is preferably electrically connected to the second pixel electrode 132 via the switching element 12T (i.e., the switching element 12T is switched to the ON state) in a period in which the potential of the first input signal and the potential of the second input signal are the same. This embodiment can cause the already charged first pixel electrode 131 to function as a conductive line, further reducing signal delays to the second pixel electrode 132.

For example, the first pixel electrode 131 is preferably electrically connected to the second pixel electrode 132 via the switching element 12T (i.e., switching element 12T is in the ON state) in a first common period from the beginning of the first period of the second input signal to the end of the first period of the first input signal, in a second common period from the beginning of the second period of the second input signal to the end of the second period of the first input signal, in a third common period from the beginning of the third period of the second input signal to the end of the third period of the first input signal, and in a fourth common period from the beginning of the fourth period of the second input signal to the end of the fourth period of the first input signal. This embodiment causes the already charged first pixel electrode 131 to function as a conductive line, further reducing signal delays to the second pixel electrode 132.

When a switching element controls electrical connection between one electrode to another electrode, the one electrode is electrically connected to the other electrode upon switching of the switching element to the ON state, and the one electrode is electrically disconnected to the other electrode upon switching of the switching element to the OFF state. Also, the state in which one electrode is electrically connected to another electrode via a switching element in a specific period may be a state in which the electrodes are electrically connected throughout the entire period or in only part of the period, but are preferably electrically connected throughout the entire period. Similarly, a state in which one electrode is not electrically connected to another electrode via a switching element in a specific period may be a state in which the electrodes are not electrically connected throughout the entire period or in only part of the period, but are preferably not electrically connected throughout the entire period.

As shown in FIG. 3 and FIG. 4, the first pixel electrode 131 and the second pixel electrode 132 are arranged adjacent to each other. The switching element 12T is arranged at the boundary between the first pixel electrode 131 and the second pixel electrode 132.

The switching element 12T is, for example, a thin film transistor (TFT). The switching element 12T includes the first semiconductor layer 12A electrically connected to the first pixel electrode 131 and the second pixel electrode 132, and the first gate electrode 12G overlapping with the first semiconductor layer 12A via the first insulating layer 121. This embodiment enables control of the switching between the ON state and OFF state of the switching element 12T based on the first control signal as the control signal input to the first switching element 12T (specifically, first gate electrode 12G). As a result, the first pixel electrode 131 and the second pixel electrode 132 can be electrically connected via the switching element 12T. Therefore, the already fully charged first pixel electrode 131 as well as the frame lines 100NL can be signal input paths to the second pixel electrode 132, thereby reducing or preventing delays in signal input to the second pixel electrode 132. The first pixel electrode 131 functions as a source electrode of the switching element 12T, and the second pixel electrode 132 functions as a drain electrode of the switching element 12T.

The first control signal is a signal different from the first input signal and the second input signal. The first control signal undergoes a repeated cycle of a first control period in which the signal is set to the first potential and a second control period in which the signal is set to the second potential which is lower than the first potential in this order. The first potential of the first control signal may be any potential that can switch the switching element 12T to the ON state, and the second potential of the first control signal may be any potential that can switch the switching element 12T to the OFF state. In other words, the first control period of the first control signal is a state in which the switching element 12T is in the ON state, and the second control period of the first control signal is a state in which the switching element 12T is in the OFF state.

The first semiconductor layer 12A preferably includes, for example, an oxide semiconductor material such as indium gallium zinc oxide (IGZO). This embodiment enables favorable switching characteristics even in large-scale panels, which tend to have charging issues, while allowing for higher on-current. The material may be any material other than IGZO as long as it achieves favorable switching characteristics even in large-scale panels while allowing for higher on-current.

The first pixel electrode 131 is electrically connected to the first semiconductor layer 12A via the first metal portion 12B. The second pixel electrode 132 is electrically connected to the first semiconductor layer 12A via the second metal portion 12C.

As shown in FIG. 6, the first substrate 100 in the liquid crystal panel 11 further includes a first gate line 1G, and the first gate electrode 12G in the switching element 12T is defined by a part of the first gate line 1G. A first control signal is input to the first gate electrode 12G via the first gate line 1G, thereby controlling the switching between the ON state and the OFF state of the switching element 12T.

Preferably, the liquid crystal panel 11 includes a plurality of switching elements 12T, and the switching elements 12T are arranged from one end portion to the other end portion of the liquid crystal panel 11 in the second direction. This embodiment can connect the first pixel electrode 131 and the second pixel electrode 132 at more points, more effectively reducing signal delays to the second pixel electrode 132.

Preferably, the liquid crystal panel 11 includes a plurality of switching elements 12T, the first pixel electrode 131 and the second pixel electrode 132 are arranged adjacent to each other, and the switching elements 12T are arranged from one end portion to the other end portion of the boundary between the first pixel electrode 131 and the second pixel electrode 132. This embodiment can connect the first pixel electrode 131 and the second pixel electrode 132 at more points, more effectively reducing signal delays to the second pixel electrode 132.

As shown in FIG. 6, a first liquid crystal capacitance 1LC is formed between the first pixel electrode 131 and the common electrode 230, and a second liquid crystal capacitance 2LC is formed between the second pixel electrode 132 and the common electrode 230.

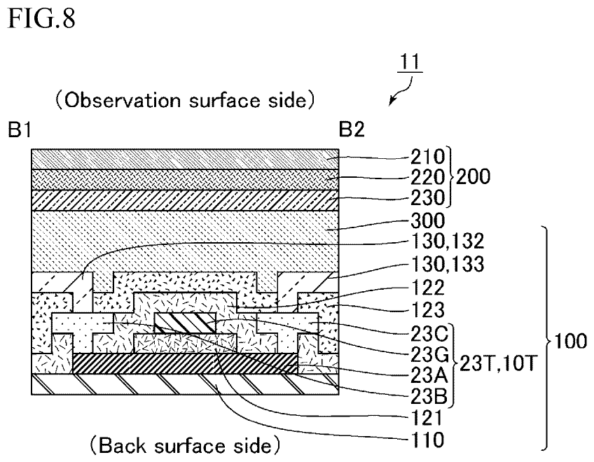

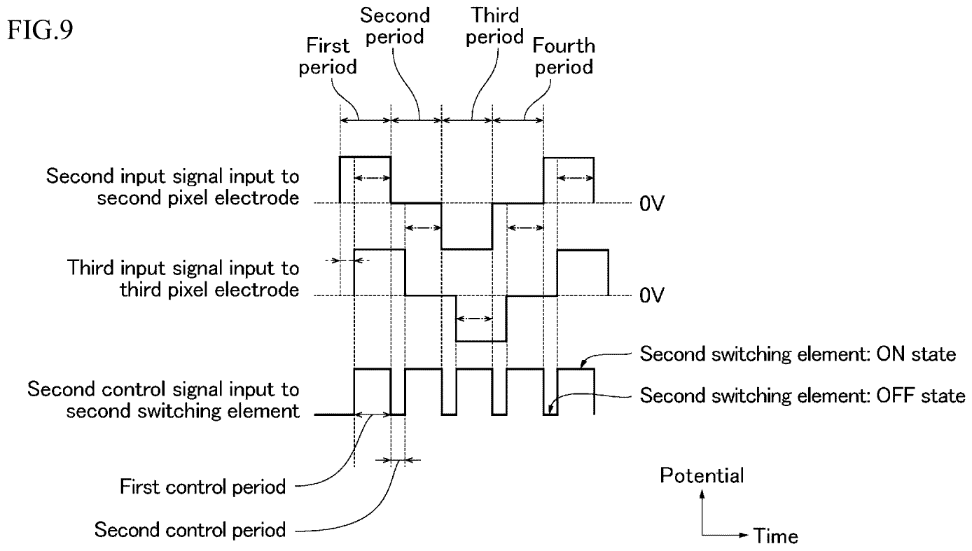

FIG. 7 is an enlarged schematic plan view of the region 11B in FIG. 2. FIG. 8 is a schematic cross-sectional view taken along line B1-B2 in FIG. 7. FIG. 9 is a timing diagram of a second input signal input to the second pixel electrode in the liquid crystal panel of Embodiment 1, a third input signal input to a third pixel electrode, and a second control signal input to a second switching element.

As shown in FIG. 7 and FIG. 8, the first substrate 100 further includes, within the display region 1AA, the third pixel electrode 133 as a third electrode electrically connected to the frame lines 100NL, and a second switching element 23T (hereinbelow, also referred to simply as a switching element 23T) configured to control electrical connection between the second pixel electrode 132 and the third pixel electrode 133. In this embodiment, switching of the switching element 23T to the ON state enables electrical connection between the second pixel electrode 132 and the third pixel electrode 133 via the switching element 23T. As a result, the second pixel electrode 132 as well as the frame lines 100NL can be signal input paths to the third pixel electrode 133, thereby reducing or preventing delays in signal input to the third pixel electrode 133. Hereinbelow, the third pixel electrode 133 as well as the first pixel electrode 131 and the second pixel electrode 132 may also be referred to collectively as “pixel electrodes 130”.

Also, as shown in FIG. 9, a third input signal is input to the third pixel electrode 133. The third input signal undergoes a repeated cycle of periods in the following order: a first period in which the signal is set more positive than the reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. The first period, the second period, the third period, and the fourth period of the second input signal overlap with and begin at timings earlier than the first period, the second period, the third period, and the fourth period of the third input signal, respectively. The second pixel electrode 132 is electrically connected to the third pixel electrode 133 via the switching element 23T in the period from the beginning of the second period of the third input signal to the end of the second period of the second input signal and in the period from the beginning of the fourth period of the third input signal to the end of the fourth period of the second input signal. This embodiment can achieve the following effect.

In the periods indicated by the dashed and dotted line arrows in FIG. 9, both of the second pixel electrode 132 and the third pixel electrode 133 are set to potentials different from the reference potential or both of the electrodes are set to the reference potential. Meanwhile, in the periods indicated by the dashed line arrows, one of the second pixel electrode 132 and the third pixel electrode 133 is set to a potential different from the reference potential, and the other is set to the reference potential. In the present embodiment, in the periods in which both of the electrodes are set to the reference potential, i.e., in the period from the beginning of the second period of the third input signal to the end of the second period of the second input signal and in the period from the beginning of the fourth period of the third input signal to the end of the fourth period of the second input signal, the second pixel electrode 132 is electrically connected to the third pixel electrode 133 via the switching element 23T (i.e., the switching element 23T is switched to the ON state). In this state, the signal input paths to the third pixel electrode 133 in FIG. 9 include the charged second pixel electrode 132 as well as the frame lines 100NL (specifically, the frame lines 100NL along the lateral sides of the liquid crystal panel 11), which enables effective reduction of signal delays to the third pixel electrode 133.

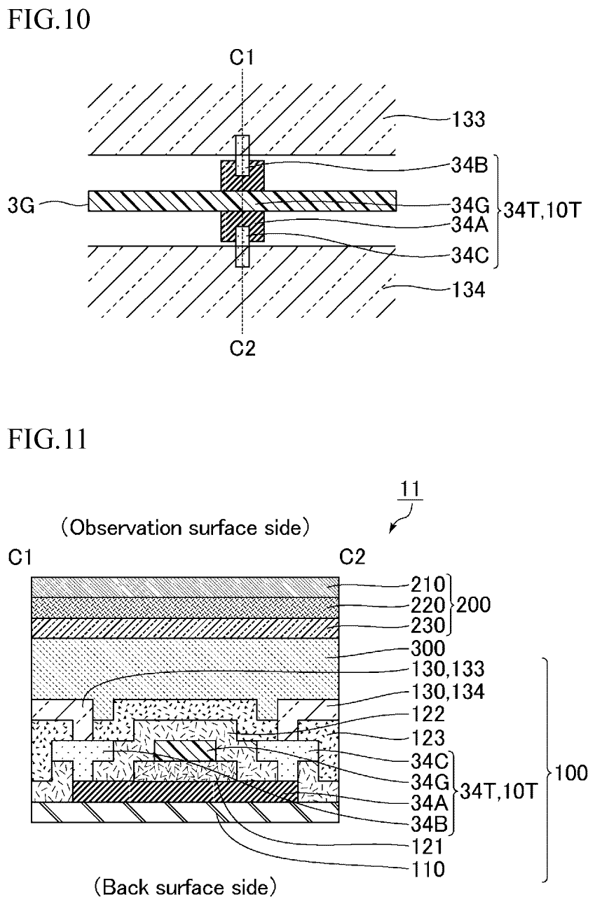

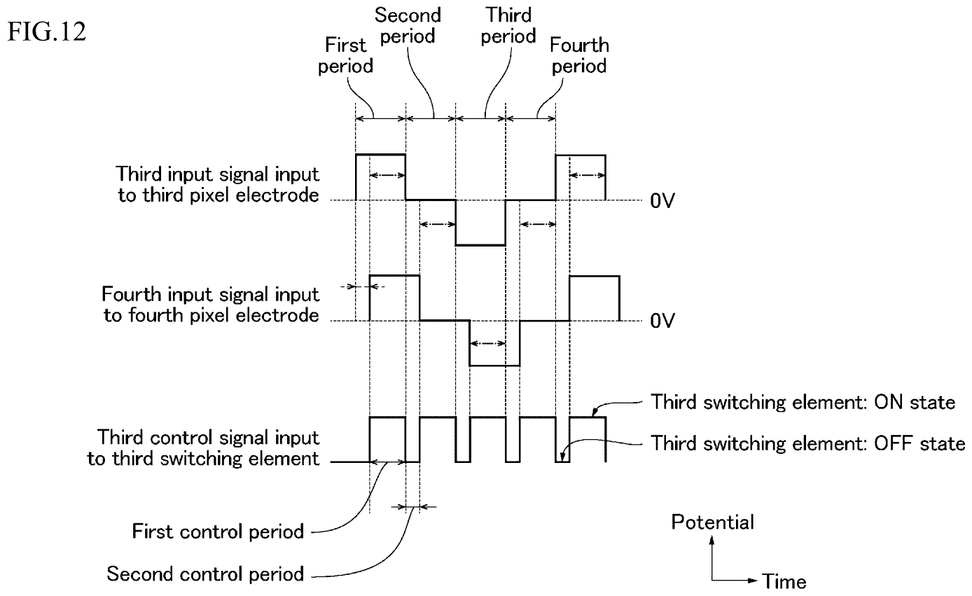

FIG. 10 is an enlarged schematic plan view of the region 11C in FIG. 2. FIG. 11 is a schematic cross-sectional view taken along line C1-C2 in FIG. 10. FIG. 12 is a timing diagram of the third input signal input to the third pixel electrode in the liquid crystal panel of Embodiment 1, a fourth input signal input to a fourth pixel electrode, and a third control signal input to a third switching element.

As shown in FIG. 10 and FIG. 11, the first substrate 100 further includes, within the display region 1AA, the fourth pixel electrode 134 as a fourth electrode electrically connected to the frame lines 100NL, and a third switching element 34T (hereinbelow, also referred to simply as a switching element 34T) configured to control electrical connection between the third pixel electrode 133 and the fourth pixel electrode 134. In this embodiment, switching of the switching element 34T to the ON state enables electrical connection between the third pixel electrode 133 and the fourth pixel electrode 134 via the switching element 34T. As a result, the third pixel electrode 133 as well as the frame lines 100NL can be signal input paths to the fourth pixel electrode 134, thereby reducing or preventing delays in signal input to the fourth pixel electrode 134. Hereinbelow, the fourth pixel electrode 134 as well as the first pixel electrode 131, the second pixel electrode 132, and the third pixel electrode 133 may also be referred to collectively as “pixel electrodes 130”. Additionally, the first switching element 12T, the second switching element 23T, and the third switching element 34T may also be referred to collectively as “switching elements 10T”.

Also, as shown in FIG. 12, a fourth input signal is input to the fourth pixel electrode 134. The fourth input signal undergoes a repeated cycle of periods in the following order: a first period in which the signal is set more positive than the reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. The first period, the second period, the third period, and the fourth period of the third input signal overlap with and begin at timings earlier than the first period, the second period, the third period, and the fourth period of the fourth input signal, respectively. The third pixel electrode 133 is electrically connected to the fourth pixel electrode 134 via the switching element 34T in the period from the beginning of the second period of the fourth input signal to the end of the second period of the third input signal and in the period from the beginning of the fourth period of the fourth input signal to the end of the fourth period of the third input signal. This embodiment can achieve the following effect.

In the periods indicated by the dashed and dotted line arrows in FIG. 12, both of the third pixel electrode 133 and the fourth pixel electrode 134 are set to potentials different from the reference potential or both of the electrodes are set to the reference potential. Meanwhile, in the periods indicated by the dashed line arrows, one of the third pixel electrode 133 and the fourth pixel electrode 134 is set to a potential different from the reference potential, and the other is set to the reference potential. In the present embodiment, in the periods in which both of the electrodes are set to the reference potential, i.e., in the period from the beginning of the second period of the fourth input signal to the end of the second period of the third input signal and in the period from the beginning of the fourth period of the fourth input signal to the end of the fourth period of the third input signal, the third pixel electrode 133 is electrically connected to the fourth pixel electrode 134 via the switching element 34T (i.e., the switching element 34T is switched to the ON state). In this state, the signal input paths to the fourth pixel electrode 134 in FIG. 12 include the charged third pixel electrode 133 as well as the frame lines 100NL (specifically, the frame lines 100NL along the lateral sides of the liquid crystal panel 11), which enables effective reduction of signal delays to the fourth pixel electrode 134.

The third pixel electrode 133 and the fourth pixel electrode 134 may be formed using the same procedure as the first pixel electrode 131 and the second pixel electrode 132.

The third pixel electrode 133 and the fourth pixel electrode 134 are preferably arranged in the same layer as the first pixel electrode 131 and the second pixel electrode 132. The first pixel electrode 131, the second pixel electrode 132, the third pixel electrode 133, and the fourth pixel electrode 134 preferably include the same material.

As shown in FIG. 2, the first pixel electrode 131, the second pixel electrode 132, the third pixel electrode 133, and the fourth pixel electrode 134 are arranged along the y-axis direction (vertical direction) corresponding to the first direction of the liquid crystal panel 11, and extend along the x-axis direction (horizontal direction) corresponding to the second direction that is perpendicular to the first direction. This embodiment can more effectively reduce or prevent signal delays in the central portion (region far from the frame lines 100NL) of each of the first pixel electrode 131, the second pixel electrode 132, the third pixel electrode 133, and the fourth pixel electrode 134 in the second direction.

As shown in FIG. 2, the first pixel electrode 131, the second pixel electrode 132, the third pixel electrode 133, and the fourth pixel electrode 134 are arranged in this order along the y-axis direction (vertical direction) corresponding to the first direction of the liquid crystal panel 11.

A third input signal undergoing an alternately repeated cycle of a positive potential and a negative potential relative to the reference potential is input to the third pixel electrode 133. A fourth input signal undergoing an alternately repeated cycle of a positive potential and a negative potential relative to the reference potential is input to the fourth pixel electrode 134.

The phase of the second input signal differs from the phase of the third input signal. The second input signal input to the second pixel electrode 132 suffices as long as the phase thereof differs from the phase of the third input signal input to the third pixel electrode 133. The waveform of the second input signal and the waveform of the third input signal may be the same as or different from each other.

The phase of the third input signal differs from the phase of the fourth input signal. The third input signal input to the third pixel electrode 133 suffices as long as the phase thereof differs from the phase of the fourth input signal input to the fourth pixel electrode 134. The waveform of the third input signal and the waveform of the fourth input signal may be the same as or different from each other.

The waveforms of the third input signal and the fourth input signal have the shapes shown in FIG. 9 and FIG. 12, for example. The third input signal undergoes a repeated cycle of periods in the following order: a first period in which the signal is set more positive than the reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. For example, the third pixel electrode 133 undergoes a repeated cycle of application of voltage with a positive polarity, no voltage application, application of voltage with a negative polarity, and no voltage application in this order. In this embodiment, the third pixel electrode 133 is charged repeatedly.

Similarly, the fourth input signal undergoes a repeated cycle of periods in the following order: a first period in which the signal is set more positive than the reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. For example, the fourth pixel electrode 134 undergoes a repeated cycle of application of voltage with a positive polarity, no voltage application, application of voltage with a negative polarity, and no voltage application in this order. In this embodiment, the fourth pixel electrode 134 is charged repeatedly.

At least one of the potentials more positive than the reference potential which are set in the first periods of the first, second, third, and fourth input signals may differ from the others, but these potentials are preferably the same. At least one of the potentials more negative than the reference potential which are set in the third periods of the first, second, third, and fourth input signals may differ from the others, but these potentials are preferably the same. This embodiment can more effectively reduce or prevent signal delays.

The lengths of the first periods of the first, second, third, and fourth input signals are preferably the same. The lengths of the second periods of the first, second, third, and fourth input signals are preferably the same. The lengths of the third periods of the first, second, third, and fourth input signals are preferably the same. The lengths of the fourth periods of the first, second, third, and fourth input signals are preferably the same. This embodiment can more effectively reduce or prevent signal delays.

As shown in FIG. 9, the waveforms of the second input signal and the third input signal are the same, and the first period, the second period, the third period, and the fourth period of the second input signal overlap with and begin at timings earlier than the first period, the second period, the third period, and the fourth period of the third input signal, respectively. This embodiment can cause the second pixel electrode 132 to be sufficiently charged and then function as a conductive line, further reducing signal delays to the third pixel electrode 133.

As shown in FIG. 9, preferably, the second pixel electrode 132 is electrically connected to the third pixel electrode 133 via the switching element 23T (i.e., the switching element 23T is in the ON state) in a period from the beginning of the first period of the third input signal to the end of the first period of the second input signal and in a period from the beginning of the third period of the third input signal to the end of the third period of the second input signal. This embodiment can cause the already charged second pixel electrode 132 to function as a conductive line when the third pixel electrode 133 is charged, thereby effectively reducing delays in signal input to the third pixel electrode 133.

At the timing at which the charging of the third pixel electrode 133 begins, the second pixel electrode 132 is more preferably fully charged. This embodiment can cause the already charged second pixel electrode 132 to function as a conductive line to further reduce signal delays to the third pixel electrode 133. Examples of the timing at which the charging of the third pixel electrode 133 begins include a timing at which the first period of the third input signal begins and a timing at which the third period of the third input signal begins.

As shown in FIG. 9, the second pixel electrode 132 is preferably electrically connected to the third pixel electrode 133 via the switching element 23T (i.e., the switching element 23T is switched to the ON state) in a period in which the potential of the second input signal and the potential of the third input signal are the same. This embodiment can cause the already charged electrode, which is the second pixel electrode 132 in the present embodiment, to function as a conductive line, further reducing signal delays to the third pixel electrode 133.

For example, the second pixel electrode 132 is preferably electrically connected to the third pixel electrode 133 via the switching element 23T (i.e., switching element 23T is in the ON state) in a first common period from the beginning of the first period of the third input signal to the end of the first period of the second input signal, in a second common period from the beginning of the second period of the third input signal to the end of the second period of the second input signal, in a third common period from the beginning of the third period of the third input signal to the end of the third period of the second input signal, and in a fourth common period from the beginning of the fourth period of the third input signal to the end of the fourth period of the second input signal. This embodiment causes the already charged second pixel electrode 132 to function as a conductive line, further reducing signal delays to the third pixel electrode 133.

As shown in FIG. 7 and FIG. 8, the second pixel electrode 132 and the third pixel electrode 133 are arranged adjacent to each other. The switching element 23T is arranged at the boundary between the second pixel electrode 132 and the third pixel electrode 133.

The switching element 23T is, for example, a TFT. The switching element 23T includes a second semiconductor layer 23A electrically connected to the second pixel electrode 132 and the third pixel electrode 133, and a second gate electrode 23G overlapping with the second semiconductor layer 23A via the first insulating layer 121. This embodiment enables control of the switching between the ON state and OFF state of the switching element 23T based on the second control signal input to the second switching element 23T (specifically, second gate electrode 23G). As a result, the second pixel electrode 132 and the third pixel electrode 133 can be electrically connected via the switching element 23T. Therefore, the already fully charged second pixel electrode 132 as well as the frame lines 100NL can be signal input paths to the third pixel electrode 133, thereby reducing or preventing delays in signal input to the third pixel electrode 133. The second pixel electrode 132 functions as a source electrode of the switching element 23T, and the third pixel electrode 133 functions as a drain electrode of the switching element 23T.

As shown in FIG. 6, the first substrate 100 in the liquid crystal panel 11 further includes a second gate line 2G, and the second gate electrode 23G in the switching element 23T is defined by a part of the second gate line 2G. A second control signal is input to the second gate electrode 23G via the second gate line 2G, thereby controlling the switching between the ON state and the OFF state of the switching element 23T.

Preferably, the liquid crystal panel 11 includes a plurality of switching elements 23T, the second pixel electrode 132 and the third pixel electrode 133 are arranged along the first direction of the liquid crystal panel 11 and extending along the second direction perpendicular to the first direction, and the switching elements 23T are arranged from one end portion to the other end portion of the liquid crystal panel 11 in the second direction. This embodiment can connect the second pixel electrode 132 and the third pixel electrode 133 at more points, more effectively reducing signal delays to the third pixel electrode 133.

Preferably, the liquid crystal panel 11 includes a plurality of switching elements 23T, the second pixel electrode 132 and the third pixel electrode 133 are arranged adjacent to each other, and the switching elements 23T are arranged from one end portion to the other end portion of the boundary between the second pixel electrode 132 and the third pixel electrode 133. This embodiment can connect the second pixel electrode 132 and the third pixel electrode 133 at more points, more effectively reducing signal delays to the third pixel electrode 133.

The second control signal is a signal different from the second input signal and the third input signal. The second control signal undergoes a repeated cycle of a first control period in which the signal is set to the first potential and a second control period in which the signal is set to the second potential which is lower than the first potential in this order. The first potential of the second control signal may be any potential that can switch the switching element 23T to the ON state, and the second potential of the second control signal may be any potential that can switch the switching element 23T to the OFF state. In other words, the first control period of the second control signal is a state in which the switching element 23T is in the ON state, and the second control period of the second control signal is a state in which the switching element 23T is in the OFF state.

As shown in FIG. 12, the waveforms of the third input signal and the fourth input signal are the same, and the first period, the second period, the third period, and the fourth period of the third input signal overlap with and begin at timings earlier than the first period, the second period, the third period, and the fourth period of the fourth input signal, respectively. This embodiment can cause the third pixel electrode 133 to be sufficiently charged and then function as a conductive line, further reducing signal delays to the fourth pixel electrode 134.

As shown in FIG. 12, preferably, the third pixel electrode 133 is electrically connected to the fourth pixel electrode 134 via the switching element 34T (i.e., the switching element 34T is in the ON state) in a period from the beginning of the first period of the fourth input signal to the end of the first period of the third input signal and in a period from the beginning of the third period of the fourth input signal to the end of the third period of the third input signal. This embodiment can cause the already charged third pixel electrode 133 to function as a conductive line when the fourth pixel electrode 134 is charged, thereby effectively reducing delays in signal input to the fourth pixel electrode 134.

At the timing at which the charging of the fourth pixel electrode 134 begins, the third pixel electrode 133 is more preferably fully charged. This embodiment can cause the already charged third pixel electrode 133 to function as a conductive line to further reduce signal delays to the fourth pixel electrode 134. Examples of the timing at which the charging of the fourth pixel electrode 134 begins include a timing at which the first period of the fourth input signal begins and a timing at which the third period of the fourth input signal begins.

As shown in FIG. 12, the third pixel electrode 133 is preferably electrically connected to the fourth pixel electrode 134 via the switching element 34T (i.e., the switching element 34T s switched to the ON state) in a period in which the potential of the third input signal and the potential of the fourth input signal are the same. This embodiment can cause the already charged electrode, which is the third pixel electrode 133 in the present embodiment, to function as a conductive line, further reducing signal delays to the fourth pixel electrode 134.

For example, the third pixel electrode 133 is preferably electrically connected to the fourth pixel electrode 134 via the switching element 34T (i.e., switching element 34T is in the ON state) in a first common period from the beginning of the first period of the fourth input signal to the end of the first period of the third input signal, in a second common period from the beginning of the second period of the fourth input signal to the end of the second period of the third input signal, a third common period from the beginning of the third period of the fourth input signal to the end of the third period of the third input signal, and a fourth common period from the beginning of the fourth period of the fourth input signal to the end of the fourth period of the third input signal. This embodiment causes the already charged third pixel electrode 133 to function as a conductive line, further reducing signal delays to the fourth pixel electrode 134.

As shown in FIG. 10 and FIG. 11, the third pixel electrode 133 and the fourth pixel electrode 134 are arranged adjacent to each other. The switching element 34T is arranged at the boundary between the third pixel electrode 133 and the fourth pixel electrode 134.

The switching element 34T is, for example, a TFT. The switching element 34T includes a third semiconductor layer 34A electrically connected to the third pixel electrode 133 and the fourth pixel electrode 134, and a third gate electrode 34G overlapping with the third semiconductor layer 34A via the first insulating layer 121. This embodiment enables control of the switching between the ON state and OFF state of the switching element 34T based on the third control signal input to the third switching element 34T (specifically, third gate electrode 34G). As a result, the third pixel electrode 133 and the fourth pixel electrode 134 can be electrically connected via the switching element 34T. Therefore, the already fully charged third pixel electrode 133 as well as the frame lines 100NL can be signal input paths to the fourth pixel electrode 134, thereby reducing or preventing delays in signal input to the fourth pixel electrode 134. The third pixel electrode 133 functions as a source electrode of the switching element 34T, and the fourth pixel electrode 134 functions as a drain electrode of the switching element 34T.

As shown in FIG. 6, the first substrate 100 in the liquid crystal panel 11 further includes a third gate line 3G, and the third gate electrode 34G in the switching element 34T is defined by a part of the third gate line 3G. A third control signal is input to the third gate electrode 34G via the third gate line 3G, thereby controlling the switching between the ON state and the off state of the switching element 34T.

Preferably, the liquid crystal panel 11 includes a plurality of switching elements 34T, the third pixel electrode 133 and the fourth pixel electrode 134 are arranged along the first direction of the liquid crystal panel 11 and extending along the second direction perpendicular to the first direction, and the switching elements 34T are arranged from one end portion to the other end portion of the liquid crystal panel 11 in the second direction. This embodiment can connect the third pixel electrode 133 and the fourth pixel electrode 134 at more points, more effectively reducing signal delays to the fourth pixel electrode 134.

Preferably, the liquid crystal panel 11 includes a plurality of switching elements 34T, the third pixel electrode 133 and the fourth pixel electrode 134 are arranged adjacent to each other, and the switching elements 34T are arranged from one end portion to the other end portion of the boundary between the third pixel electrode 133 and the fourth pixel electrode 134. This embodiment can connect the third pixel electrode 133 and the fourth pixel electrode 134 at more points, more effectively reducing signal delays to the fourth pixel electrode 134.

The third control signal is a signal different from the third input signal and the fourth input signal. The third control signal undergoes a repeated cycle of a first control period in which the signal is set to the first potential and a second control period in which the signal is set to the second potential which is lower than the first potential in this order. The first potential of the third control signal may be any potential that can switch the switching element 34T to the ON state, and the second potential of the third control signal may be any potential that can switch the switching element 34T to the OFF state. In other words, the first control period of the third control signal is a state in which the switching element 34T is in the ON state, and the second control period of the third control signal is a state in which the switching element 34T is in the OFF state.

The first potentials set in the first control periods of the first, second, and third control signals may be the same as or different from one another. The second potentials set in the second control periods of the first, second, and third control signals may be the same as or different from one another.

The lengths of the first control periods of the first, second, and third control signals are preferably the same. The lengths of the second control periods of the first, second, and third control signals are preferably the same. This embodiment can more effectively reduce or prevent signal delays.

The second semiconductor layer 23A and the third semiconductor layer 34A are similar to the first semiconductor layer 12A.

The second pixel electrode 132 is electrically connected to the second semiconductor layer 23A via a first metal portion 23B. The third pixel electrode 133 is electrically connected to the second semiconductor layer 23A via a second metal portion 23C. The third pixel electrode 133 is electrically connected to the third semiconductor layer 34A via a first metal portion 34B. The fourth pixel electrode 134 is electrically connected to the third semiconductor layer 34A via a second metal portion 34C.

The first metal portions 23B and 34B are similar to the first metal portion 12B, and the second metal portions 23C and 34C are similar to the second metal portion 12C.

As shown in FIG. 6, a third liquid crystal capacitance 3LC is formed between the third pixel electrode 133 and the common electrode 230, and a fourth liquid crystal capacitance 4LC is formed between the fourth pixel electrode 134 and the common electrode 230.

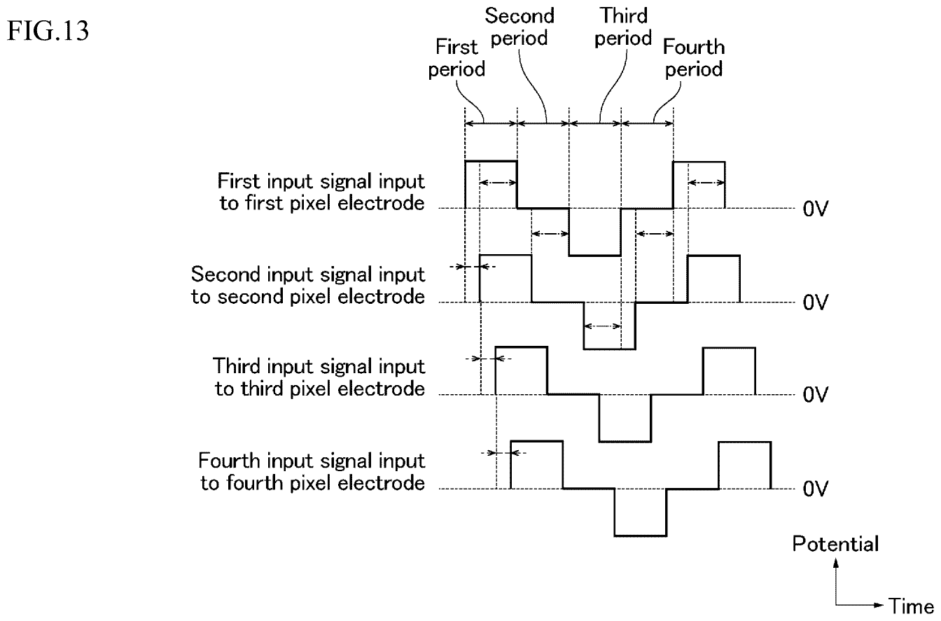

FIG. 13 is a timing diagram of the first, second, third, and fourth input signals input to the first, second, third, and fourth pixel electrodes in the liquid crystal panel of Embodiment 1. In the liquid crystal panel 11 of the present embodiment, it suffices as long as adjacent pixel electrodes 130 are connected to each other via a switching element such as a TFT. In FIG. 3 to FIG. 5, a structure is shown in which the first pixel electrode 131 and the second pixel electrode 132 are connected by the first switching element 12T. Similar structures are employed between the second pixel electrode 132 and the third pixel electrode 133 as shown in FIG. 7 to FIG. 9, and between the third pixel electrode 133 and the fourth pixel electrode 134 as shown in FIG. 10 to FIG. 12. The first input signal input to the first pixel electrode 131, the second input signal input to the second pixel electrode 132, the third input signal input to the third pixel electrode 133, and the fourth input signal input to the fourth pixel electrode 134 change as shown in FIG. 13, for example.

Next, the image display panel 12 is described. The image display panel 12 preferably includes a plurality of pixels. The pixels are display units for displaying images and include, in the case of color display, red, blue, and green pixels, for example.

The image display panel 12 may include a TFT substrate in which thin film TFTs are arranged. The TFT substrate may include, on a support substrate, a plurality of gate lines extending parallel to one another and a plurality of source lines extending parallel to one another in a direction in which they intersect the gate lines via a gate insulator. The gate lines and the source lines may be formed in a grid pattern in a plan view. The regions defined by the gate lines and the source lines correspond to pixels.

The support substrate is preferably a transparent substrate and may be, for example, a glass substrate or a plastic substrate.

TFTs serving as switching elements may be arranged in the respective pixels at or near the respective intersections of the gate lines and the source lines. The gate terminal of each TFT may be connected to the corresponding gate line, the source terminal of the TFT may be connected to the corresponding source line, and the drain terminal of the TFT may be connected to the corresponding pixel electrode. The image display panel 12 may include a common electrode to which a common electrode voltage is applied, in addition to the pixel electrodes.

The image display panel 12 may be a liquid crystal display panel, an organic light emitting diode (OLED) panel including OLEDs, or a quantum dot-light emitting diode (QD-LED) panel including QD-LEDs. The OLEDs and QD-LEDs herein are also referred to simply as light emitting diodes (LEDs) when no distinction is made between them.

When the image display panel 12 is a liquid crystal display panel, the image display panel 12 includes a TFT substrate, a counter substrate facing the TFT substrate, and a liquid crystal layer located between the TFT substrate and the counter substrate. The TFT substrate or the counter substrate includes a color filter layer.

When the image display panel 12 is an OLED panel or a QD-LED panel, the configuration of each light emitting diode is not limited, and may be, for example, a stack including a cathode, an electron transport layer, a light-emitting layer, a hole transport layer, and an anode in this order.

The materials of the cathode and the anode are not limited, and may each be, for example, a transparent conductive material such as indium tin oxide (ITO), indium zinc oxide (IZO), In₃O₃, SnO₂, or ZnO, aluminum, silver, or an alloy of these.

In the case of a top-emitting LED, the pixel electrodes in the TFT substrate may be used as the anode while the common electrode may be used as the cathode. Reflective electrode(s) formed from aluminum, silver, or an alloy of these may be used as the anode while any of the above transparent conductive materials may be used as the cathode.

The hole transport layer transports holes injected from the anode to the light-emitting layer. The material of the hole transport layer is not limited and may be, for example, an amine-based compound such as N,N,N′,N′-tetraphenylbenzidine or a derivative thereof.

The electron transport layer transports electrons injected from the cathode to the light-emitting layer. The material of the electron transport layer is not limited and may be, for example, a phenanthroline derivative such as 2,9-dimethyl-4,7-diphenyl-1,10-phenanthroline (BCP), a quinoline derivative such as tris(8-quinolinolato)aluminum (Alq3), an azaindolizine derivative, an oxadiazole derivative, a perylene derivative, a pyridine derivative, a pyrimidine derivative, a quinoxaline derivative, a diphenylquinone derivative, or a nitro-substituted fluorene derivative.

An electron injection layer may be arranged between the cathode and the electron transport layer. A hole injection layer may be arranged between the anode and the hole transport layer. The material of the electron injection layer can be an inorganic insulating material. Examples thereof include oxides of an alkali metal, halides of an alkali metal, oxides of an alkaline earth metal, and halides of an alkaline earth metal.

When the image display panel 12 is an OLED panel, the light-emitting layer may include as a luminous material a fluorescent material or a phosphorescent material, for example.

When the image display panel 12 is a QD-LED panel, the light-emitting layer may include quantum dots as the luminous material. The quantum dots are nano-sized (e.g., average particle size of from 2 to 10 nm) semiconductor crystals that exhibit optical characteristics governed by quantum mechanics. Examples thereof include colloidal particles each of which is composed of about 10 to 50 atoms.

### Embodiment 2

In the present embodiment, features unique to the present embodiment are mainly described, and description of the same contents as in Embodiment 1 is omitted. The present embodiment is substantially the same as Embodiment 1, except that the first control signal is different.

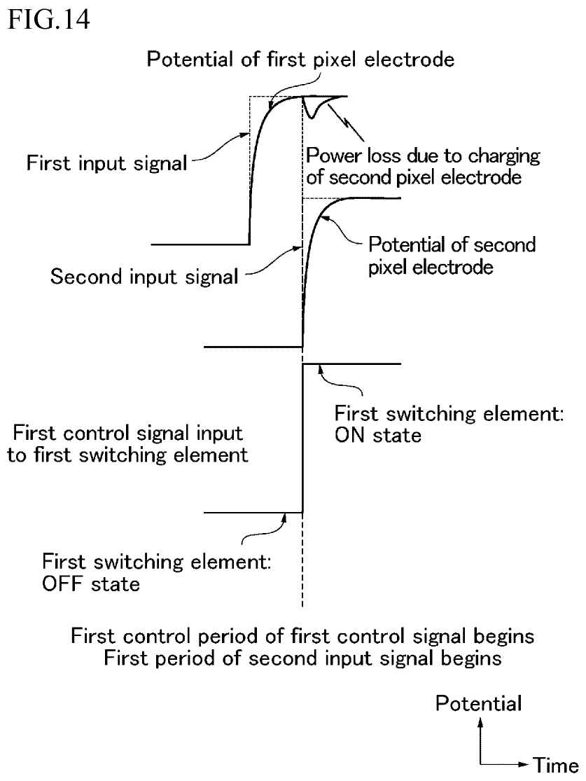

FIG. 14 is a timing diagram of the time-dependent potential changes of the first pixel electrode and the second pixel electrode in the liquid crystal panel of Embodiment 1, and the first control signal. As shown in FIG. 14, in Embodiment 1, the timing at which the switching element 12T is switched to the ON state coincides with the timing at which the second input signal input to the second pixel electrode 132 changes. Specifically, the timing at which the first period of the first control signal begins coincides with the timing at which the first period of the second input signal begins. In other words, the timing at which the first pixel electrode 131 is electrically connected to the second pixel electrode 132 via the switching element 12T coincides with the timing at which the first period of the second input signal begins. In this case, depending on the input resistance of the first pixel electrode 131, the potential of the first pixel electrode 131 may possibly undergo a sudden and significant drop to adversely affect the display quality.

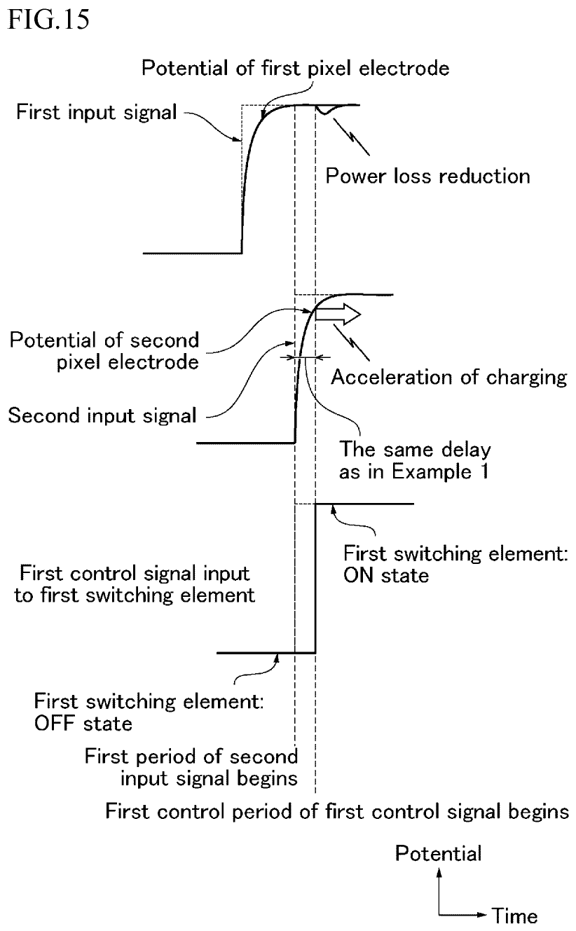

FIG. 15 is a timing diagram of the time-dependent potential changes of the first pixel electrode and the second pixel electrode in a liquid crystal panel of Embodiment 2, and the first control signal. In the present embodiment, as shown in FIG. 15, the first control signal rises slightly later than the second input signal, and the second pixel electrode 132 is connected to the first pixel electrode 131 at a timing at which the second pixel electrode 132 is charged to some degree, thereby reducing the potential drop of the first pixel electrode 131 which can occur in Embodiment 1.

The timing at which the first pixel electrode 131 in the present embodiment is electrically connected to the second pixel electrode 132 via the switching element 12T is later than the timing at which the first period of the second input signal begins. In other words, the timing at which the switching element 12T in the present embodiment is switched to the ON state is later than the timing at which the charging of the second pixel electrode 132 begins. Specifically, the timing at which the switching element 12T is switched to the ON state is later than the timing at which the first period of the second input signal begins. This embodiment enables the second pixel electrode 132 to be connected to the first pixel electrode 131 at the timing at which the second pixel electrode 132 is charged to some degree, thereby reducing the potential drop of the first pixel electrode 131 which can occur in Embodiment 1.

The timing at which the first pixel electrode 131 is electrically connected to the second pixel electrode 132 via the switching element 12T (the timing at which the switching element 12T is switched to the ON state, i.e., the timing at which the first control period of the first control signal begins) is preferably later than the timing at which the first period of the second input signal begins (the timing at which the charging of the second pixel electrode 132 begins) by 1 msec or more and 0.3 msec or less. This embodiment can effectively reduce or prevent the potential drop of the first pixel electrode 131.

In the liquid crystal panel 11 of Embodiment 2, the first pixel electrode 131 and the second pixel electrode 132 are electrically connected to each other in a state where the potential difference between the first pixel electrode 131 and the second pixel electrode 132 is smaller than that in the liquid crystal panel of Embodiment 1. As compared with Embodiment 1, the effect of accelerating the charging decreases but the potential drop of the first pixel electrode 131 is reduced in Embodiment 2, which can avoid the adverse effect on the display quality.

The configuration of the switching element 23T is similar to that of the switching element 12T. The timing at which the second pixel electrode 132 in the present embodiment is electrically connected to the third pixel electrode 133 via the switching element 23T is later than the timing at which the first period of the third input signal begins. In other words, the timing at which the switching element 23T is switched to the ON state is later than the timing at which the charging of the third pixel electrode 133 begins. Specifically, the timing at which the switching element 23T is switched to the ON state is later than the timing at which the first period of the third input signal begins. This embodiment enables the third pixel electrode 133 to be connected to the second pixel electrode 132 at the timing at which the third pixel electrode 133 is charged to some degree, reducing the potential drop of the second pixel electrode 132 which can occur in Embodiment 1.

The timing at which the second pixel electrode 132 is electrically connected to the third pixel electrode 133 via the switching element 23T (the timing at which the switching element 23T is switched to the ON state, i.e., the timing at which the first control period of the second control signal begins) is preferably later than the timing at which the first period of the third input signal begins (the timing at which the charging of the third pixel electrode 133 begins) by 1 msec or more and 0.3 msec or less. This embodiment can effectively reduce or prevent the potential drop of the second pixel electrode 132.

In the liquid crystal panel 11 of Embodiment 2, the second pixel electrode 132 and the third pixel electrode 133 are electrically connected to each other in a state where the potential difference between the second pixel electrode 132 and the third pixel electrode 133 is smaller than that in the liquid crystal panel of Embodiment 1. As compared with Embodiment 1, the effect of accelerating the charging decreases but the potential drop of the second pixel electrode 132 is reduced in Embodiment 2, which can avoid the adverse effect on the display quality.

The configuration of the switching element 34T is similar to that of the switching element 12T. The timing at which the third pixel electrode 133 in the present embodiment is electrically connected to the fourth pixel electrode 134 via the switching element 34T is later than the timing at which the first period of the fourth input signal begins. In other words, the timing at which the switching element 34T is switched to the ON state is later than the timing at which the charging of the fourth pixel electrode 134 begins. Specifically, the timing at which the switching element 34T is switched to the ON state is later than the timing at which the first period of the fourth input signal begins. This embodiment enables the fourth pixel electrode 134 to be connected to the third pixel electrode 133 at the timing at which the fourth pixel electrode 134 is charged to some degree, reducing the potential drop of the third pixel electrode 133 which can occur in Embodiment 1.

The timing at which the third pixel electrode 133 is electrically connected to the fourth pixel electrode 134 via the switching element 34T (the timing at which the switching element 34T is switched to the ON state, i.e., the timing at which the first control period of the third control signal begins) is preferably later than the timing at which the first period of the fourth input signal begins (the timing at which the charging of the fourth pixel electrode 134 begins) by 1 msec or more and 0.3 msec or less. This embodiment can effectively reduce or prevent the potential drop of the third pixel electrode 133.

In the liquid crystal panel 11 of Embodiment 2, the third pixel electrode 133 and the fourth pixel electrode 134 are electrically connected to each other in a state where the potential difference between the third pixel electrode 133 and the fourth pixel electrode 134 is smaller than that in the liquid crystal panel of Embodiment 1. As compared with Embodiment 1, the effect of accelerating the charging decreases but the potential drop of the third pixel electrode 133 is reduced in Embodiment 2, which can avoid the adverse effect on the display quality.

### Embodiment 3

In the present embodiment, features unique to the present embodiment are mainly described, and description of the same contents as in Embodiment 1 is omitted. The present embodiment is substantially the same as Embodiment 1, except that the first control signal is different.

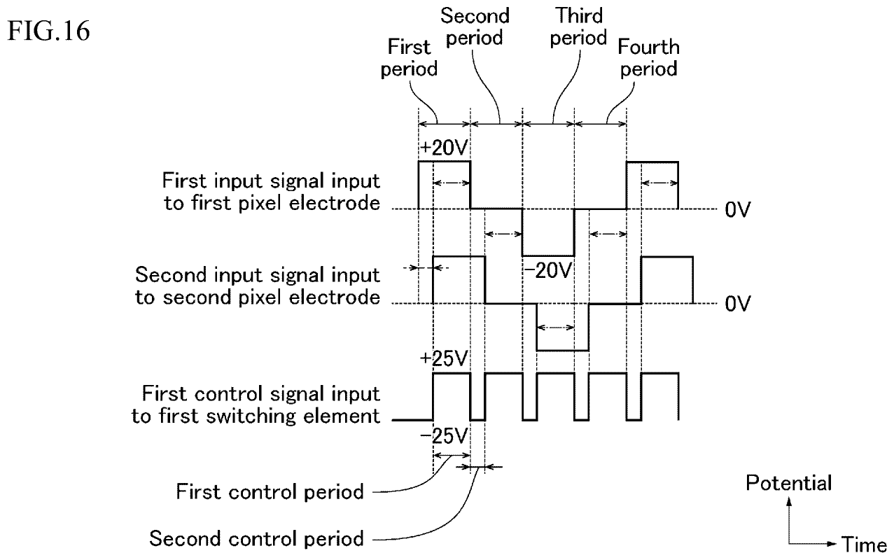

FIG. 16 is a timing diagram of a first input signal input to a first pixel electrode in the liquid crystal panel of Embodiment 1, a second input signal input to a second pixel electrode, and a first control signal input to a first switching element. In Embodiment 1, when voltage with a positive polarity or a negative polarity is applied to the first pixel electrode 131 and the second pixel electrode 132, i.e., both when the electrode is switched to the state with voltage applied (the ON state) and when the electrode is switched to the state with no voltage applied (the OFF state), the switching element 12T is switched to the ON state by the first control signal. In other words, the switching element 12T is in the ON state from the beginning of the first period of the second input signal to the end of the first period of the first input signal, from the beginning of the second period of the second input signal to the end of the second period of the first input signal, from the beginning of the third period of the second input signal to the end of the third period of the first input signal, and from the beginning of the fourth period of the second input signal to the end of the fourth period of the first input signal.

Regarding the first potential and second potential of the first, second, and third control signals, when a positive polarity is written into the pixel electrodes 130, in order to apply a sufficiently high voltage between the gate electrodes and the source electrodes of the TFTs as the switching elements 10T, the first potentials of the first, second, and third control signals should be high. Also, when the pixel electrode 130 has a negative polarity, it is required to reliably turn off the TFT, and the second potential should be sufficiently low in this case. Due to these conditions, the drive voltages of the control signals tend to be high. Although it depends on the liquid crystal material and the cell thickness, for example, as shown in FIG. 16, the drive voltages are about ±25 V at maximum. The drive voltages are preferably reduced because a high drive voltage causes degradation of the TFTs and an increase in power consumption.

Based on the above, in order to reduce the drive voltage in Embodiment 3, the switching element 12T is turned ON only at the timing at which the first pixel electrode 131 and the second pixel electrode 132 are switched from the ON state to the OFF state.

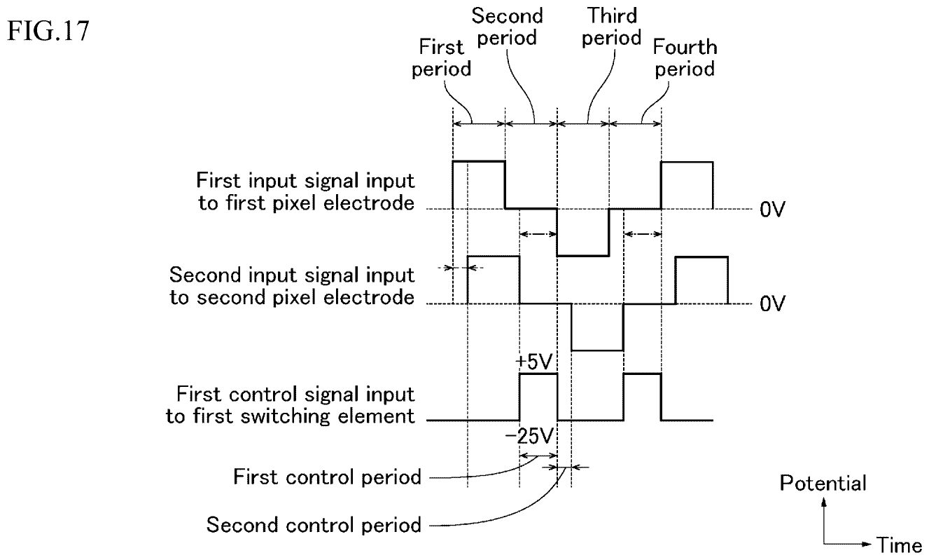

FIG. 17 is a timing diagram of a first input signal input to the first pixel electrode in the liquid crystal panel of Embodiment 3, a second input signal input to the second pixel electrode, and a first control signal input to the first switching element. As shown in FIG. 17, the first pixel electrode 131 in the present embodiment is not electrically connected to the second pixel electrode 132 in the period from the beginning of the first period of the second input signal to the end of the first period of the first input signal and in the period from the beginning of the third period of the second input signal to the end of the third period of the first input signal. In other words, the switching element 12T is in the ON state in the second common period from the beginning of the second period of the second input signal to the end of the second period of the first input signal and in the fourth common period from the beginning of the fourth period of the second input signal to the end of the fourth period of the first input signal, and is in the OFF state in the first common period from the beginning of the first period of the second input signal to the end of the first period of the first input signal and in the third common period from the beginning of the third period of the second input signal to the end of the third period of the first input signal. This embodiment can reduce the drive voltage of the switching element 12T. As described above, reduction in the drive voltage is expected to reduce power consumption and enhance the TFT reliability.

The configuration of the switching element 23T is similar to that of the switching element 12T. The second pixel electrode 132 in the present embodiment is not electrically connected to the third pixel electrode 133 in the period from the beginning of the first period of the third input signal to the end of the first period of the second input signal and in the period from the beginning of the third period of the third input signal to the end of the third period of the second input signal. In other words, the switching element 23T is in the ON state in the second common period from the beginning of the second period of the third input signal to the end of the second period of the second input signal and in the fourth common period from the beginning of the fourth period of the third input signal to the end of the fourth period of the second input signal, and is in the OFF state in the first common period from the beginning of the first period of the third input signal to the end of the first period of the second input signal and in the third common period from the beginning of the third period of the third input signal to the end of the third period of the second input signal. This embodiment can reduce the drive voltage of the switching element 23T. As described above, reduction in the drive voltage is expected to reduce power consumption and enhance the TFT reliability.

The configuration of the switching element 34T is similar to that of the switching element 12T. The third pixel electrode 133 in the present embodiment is not electrically connected to the fourth pixel electrode 134 in the period from the beginning of the first period of the fourth input signal to the end of the first period of the third input signal and in the period from the beginning of the third period of the fourth input signal to the end of the third period of the third input signal. In other words, the switching element 34T is in the ON state in the second common period from the beginning of the second period of the fourth input signal to the end of the second period of the third input signal and in the fourth common period from the beginning of the fourth period of the fourth input signal to the end of the fourth period of the third input signal, and is in the OFF state in the first common period from the beginning of the first period of the fourth input signal to the end of the first period of the third input signal and in the third common period from the beginning of the third period of the fourth input signal to the end of the third period of the third input signal. This embodiment can reduce the drive voltage of the switching element 34T. As described above, reduction in the drive voltage is expected to reduce power consumption and enhance the TFT reliability.

### Embodiment 4

In the present embodiment, features unique to the present embodiment are mainly described, and description of the same contents as in Embodiment 1 is omitted. The present embodiment is substantially the same as Embodiment 1, except that an overshoot is applied to the second input signal input to the second pixel electrode 132. First, the issue observed in the case of applying an overshoot to the second input signal in Embodiment 1 is described.

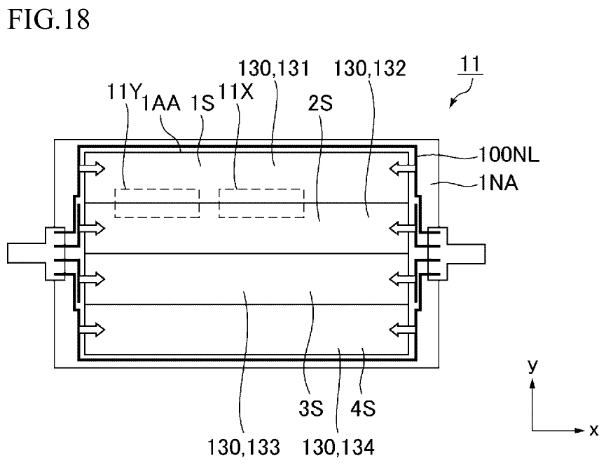

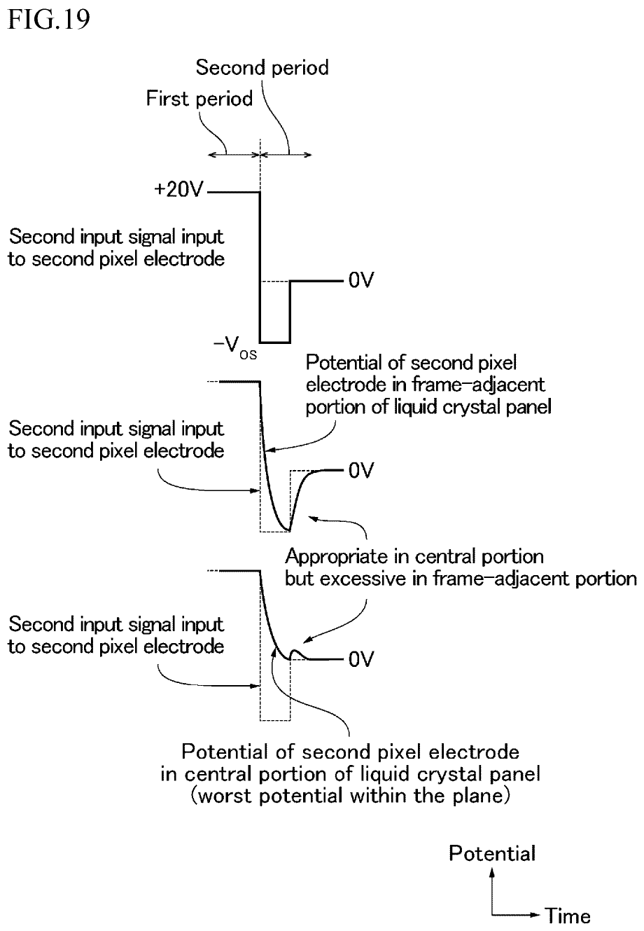

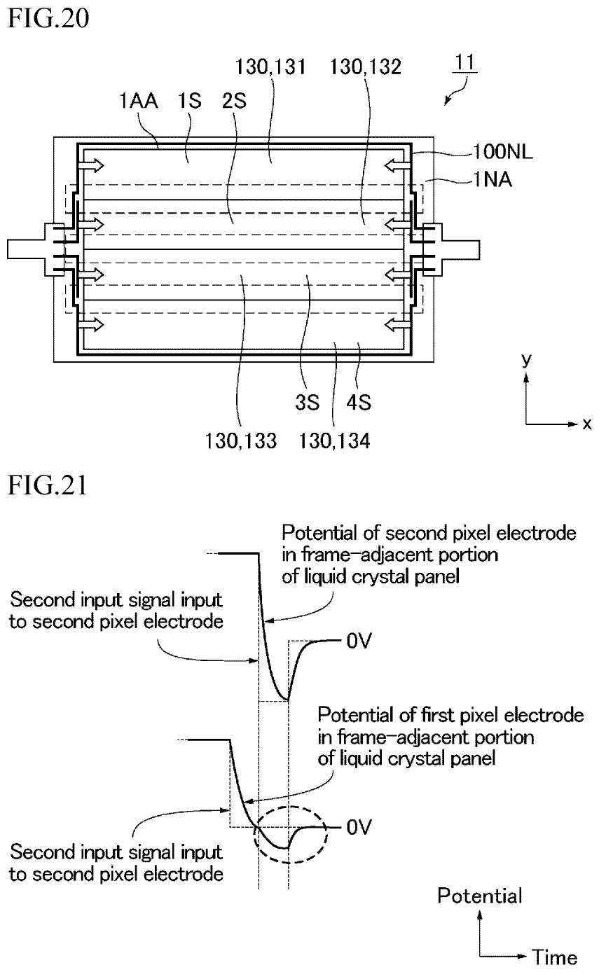

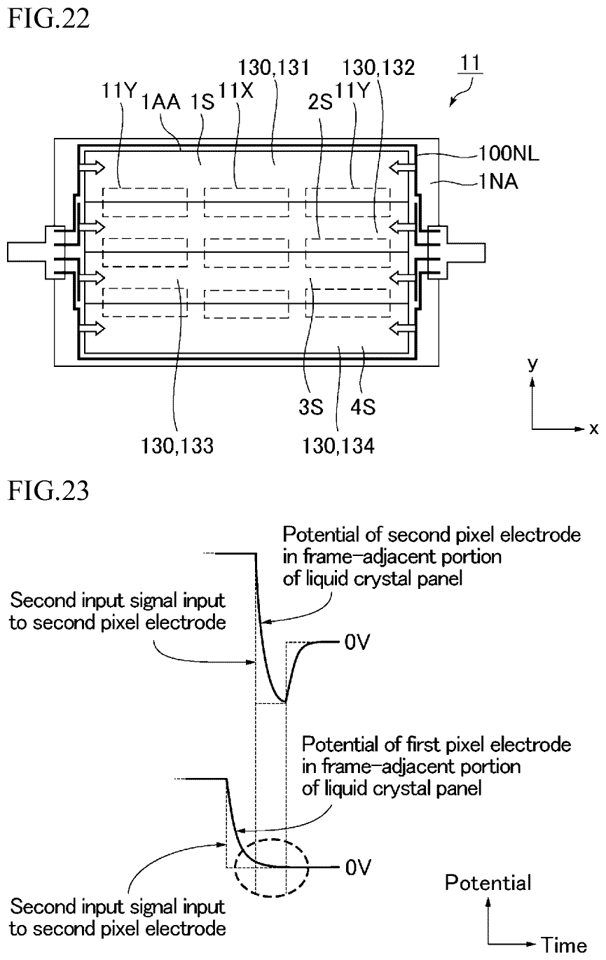

FIG. 18 is a schematic plan view of the liquid crystal panel of Embodiment 1. FIG. 19 is a timing diagram of the time-dependent potential change of the second pixel electrode in the liquid crystal panel of Embodiment 1 when an overshoot is applied to the second input signal input to the second pixel electrode. FIG. 20 is a schematic plan view illustrating a case where the first pixel electrode and the second pixel electrode are connected by the first switching element across the entire lateral region of the liquid crystal panel of Embodiment 1. FIG. 21 is a timing diagram of the time-dependent potential changes of the first pixel electrode and the second pixel electrode in a frame-adjacent portion of a liquid crystal panel having the structure shown in FIG. 20. FIG. 22 is a schematic plan view of the liquid crystal panel of Embodiment 4. FIG. 23 is a timing diagram of the time-dependent potential changes of the first pixel electrode and the second pixel electrode in a frame-adjacent portion of the liquid crystal panel of Embodiment 4.

Typically, the internal waveform of the second pixel electrode 132 experiences the greatest delay in the central portion 11X of the liquid crystal panel 11 shown in FIG. 18. To drive the potential toward the desired potential (e.g., 0 V (reference potential) in FIG. 19) as rapidly as possible in the central portion 11X of the liquid crystal panel 11 in which the greatest delay occurs, an overshoot is applicable in which the second input signal is momentarily driven to a negative potential (i.e., a potential more negative than the reference potential) and subsequently returned to 0 V (reference potential) as shown in FIG. 19.

When the overshoot is applied, the second pixel electrode 132 is readily driven to the desired potential (0 V (reference potential)), though with some delays and noises in the central portion 11X of the liquid crystal panel 11. However, in frame-adjacent portions 11Y, the change in the voltage of the second input signal including the overshoot is input almost as is, tending to make a sudden and excessive change in potential of the second pixel electrode 132. Accordingly, as shown in FIG. 19, application of an overshoot may possibly cause the voltage to experience a great waveform change within the plane of the second pixel electrode 132.

In such a case, when the first pixel electrode 131 and the second pixel electrode 132 are connected across the entire lateral region of the liquid crystal panel 11 as indicated by the dashed line rectangles shown in FIG. 20, the excessive potential change in the frame-adjacent portions 11Y may propagate to the already charged first pixel electrode 131 as indicated by the dashed line circle in FIG. 21, causing a temporal large potential shift of the first pixel electrode 131 to further decrease the display quality.

To address the above issue, in the present embodiment, as shown in FIG. 22, the switching element 12T to be included within the display region 1AA is arranged only near an in-plane worst point (in many cases, central portion 11X), not across the lateral region of the liquid crystal panel 11. In other words, the liquid crystal panel 11 includes one or more switching elements 12T, and the one or more switching elements 12T are arranged in the central portion 11X of the liquid crystal panel 11 in the second direction, and not arranged in the frame-adjacent portions 11Y of the liquid crystal panel 11 in the second direction. When an overshoot is applied to the second input signal, the potential of the second pixel electrode 132 tends to shift in portions other than the central portion 11X of the liquid crystal panel 11. However, when the switching elements 12T are arranged in the central portion 11X of the liquid crystal panel 11 and are not arranged in the frame-adjacent portions 11Y of the liquid crystal panel 11, the first pixel electrode 131 and the second pixel electrode 132, which are adjacent to each other, are not connected in the frame-adjacent portions 11Y. This can reduce or prevent the influence of the second pixel electrode 132 with a potential shift on the already-charged adjacent first pixel electrode 131. As a result, as indicated by the dashed line circle in FIG. 23, a shift of the potential of the first pixel electrode 131 from the desired potential can be avoided, thereby improving the display quality.

The central portion 11X of the liquid crystal panel 11 refers to a region arranged in the central region among three regions obtained by equally dividing the region extending from one end portion to the other end portion of the liquid crystal panel 11 in the first direction.

The configuration of the switching element 23T is similar to that of the switching element 12T. In other words, the liquid crystal panel 11 includes one or more switching elements 23T, and the one or more switching elements 23T are arranged in the central portion 11X of the liquid crystal panel 11 in the second direction, and not arranged in the frame-adjacent portions 11Y of the liquid crystal panel 11 in the second direction. When an overshoot is applied to the third input signal, the potential of the third pixel electrode 133 tends to shift in portions other than the central portion 11X of the liquid crystal panel 11. However, when the switching elements 23T are arranged in the central portion 11X of the liquid crystal panel 11 and are not arranged in the frame-adjacent portions 11Y of the liquid crystal panel 11, the second pixel electrode 132 and the third pixel electrode 133, which are adjacent to each other, are not connected in the frame-adjacent portions 11Y. This can reduce or prevent the influence of the third pixel electrode 133 with a potential shift on the already-charged adjacent second pixel electrode 132. As a result, a shift of the potential of the second pixel electrode 132 from the desired potential can be avoided, thereby improving the display quality.

The configuration of the switching element 34T is similar to that of the switching element 12T. In other words, the liquid crystal panel 11 includes one or more switching elements 34T, and the one or more switching elements 34T are arranged in the central portion 11X of the liquid crystal panel 11 in the second direction, and not arranged in the frame-adjacent portions 11Y of the liquid crystal panel 11 in the second direction. When an overshoot is applied to the fourth input signal, the potential of the fourth pixel electrode 134 tends to shift in portions other than the central portion 11X of the liquid crystal panel 11. However, when the switching elements 34T are arranged in the central portion 11X of the liquid crystal panel 11 and are not arranged in the frame-adjacent portions 11Y of the liquid crystal panel 11, the third pixel electrode 133 and the fourth pixel electrode 134, which are adjacent to each other, are not connected in the frame-adjacent portions 11Y. This can reduce or prevent the influence of the fourth pixel electrode 134 with a potential shift on the already-charged adjacent third pixel electrode 133. As a result, a shift of the potential of the third pixel electrode 133 from the desired potential can be avoided, thereby improving the display quality.

### Embodiment 5

In the present embodiment, features unique to the present embodiment are mainly described, and description of the same contents as in Embodiment 1 is omitted. The present embodiment is substantially the same as Embodiment 4, except that in the present embodiment, in the frame-adjacent portions 11Y of the liquid crystal panel 11, the first pixel electrode 131 and the second pixel electrode 132 are connected via a switching element including a frame-adjacent portion first gate electrode which is different from the first gate electrode 12G.

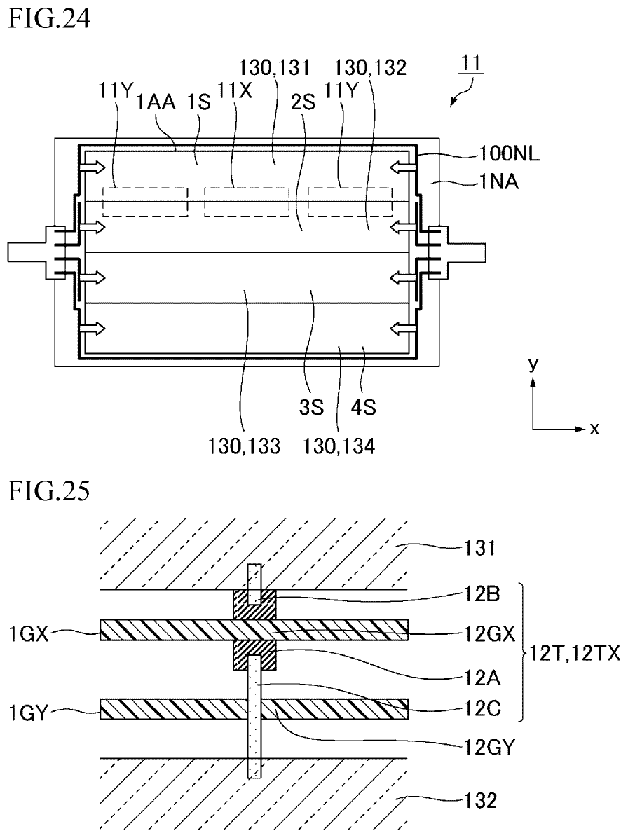

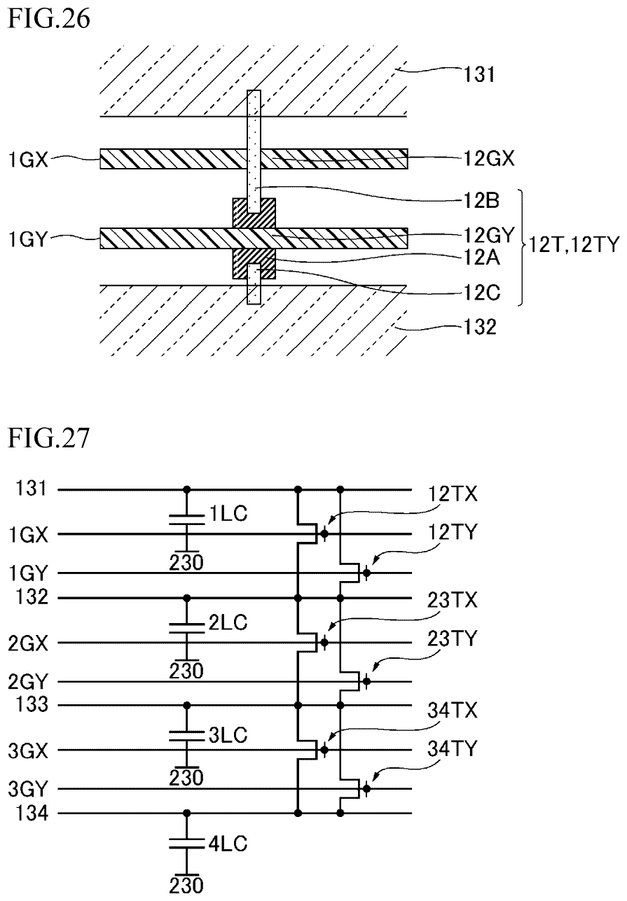

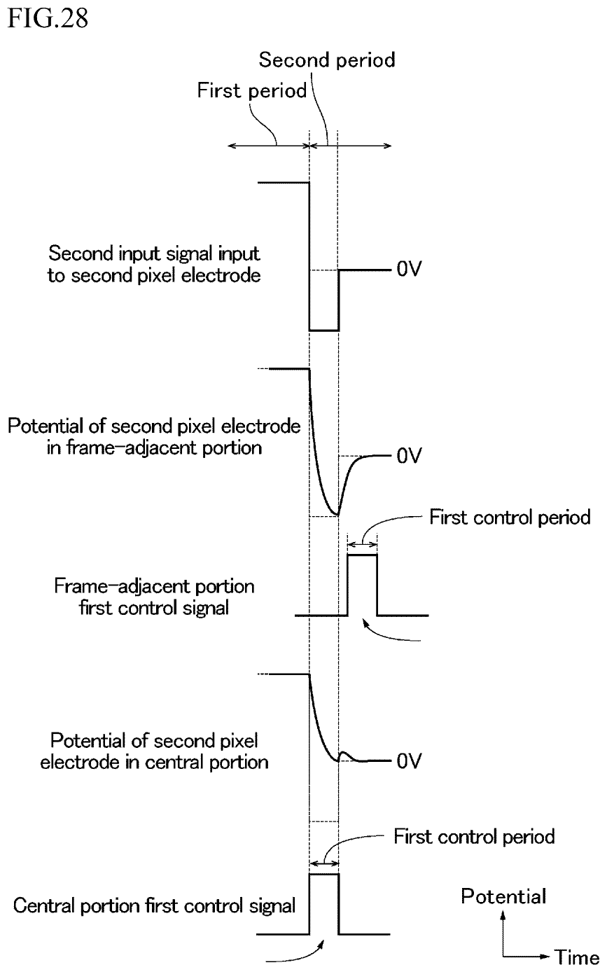

FIG. 24 is a schematic plan view of a liquid crystal panel of Embodiment 5. FIG. 25 is a schematic cross-sectional view of the central portion of the liquid crystal panel of Embodiment 5. FIG. 26 is a schematic cross-sectional view of a frame-adjacent portion of the liquid crystal panel of Embodiment 5. FIG. 27 is an equivalent circuit diagram of the liquid crystal panel of Embodiment 5. FIG. 28 is a timing diagram of the time-dependent potential changes of the second pixel electrode in the central portion and the frame-adjacent portion of the liquid crystal panel of Embodiment 5.

In Embodiment 4, the switching elements 12T are arranged only in the central portion 11X of the liquid crystal panel 11. In the present embodiment, a switching element controlled by a control signal different from that used in the central portion 11X of the liquid crystal panel 11 is arranged at the boundary between the first pixel electrode 131 and the second pixel electrode 132 in each frame-adjacent portion 11Y.

Specifically, as shown in FIG. 24 to FIG. 27, the liquid crystal panel 11 includes a plurality of first switching elements 12T arranged between the first pixel electrode 131 and the second pixel electrode 132, and the first switching elements 12T include a central portion first switching element 12TX as a switching element for the central portion which is arranged in the central portion 11X of the liquid crystal panel 11 in the second direction, and frame-adjacent portion first switching elements 12TY arranged as switching elements for the frame-adjacent portions which are arranged in the frame-adjacent portions 11Y of the liquid crystal panel 11 in the second direction.

As described in Embodiment 4, when an overshoot is applied to the second input signal, the second pixel electrode 132 may experience significantly different potential changes in the frame-adjacent portions 11Y and the central portion 11X. In such a case, the difference in potential change between the central portion 11X and frame-adjacent portions 11Y of the second pixel electrode 132 can be made small by employing a structure as used in the present embodiment in which the central portion first switching element 12TX is arranged in the central portion 11X of the liquid crystal panel 11 and the frame-adjacent portion first switching elements 12TY are arranged in the respective frame-adjacent portions 11Y of the liquid crystal panel 11.

Specifically, as shown in FIG. 24 and FIG. 28, in the second period, the first input signal and the second input signal are temporarily set more negative than the reference potential and subsequently set to the reference potential, the first pixel electrode 131 connected to the central portion first switching element 12TX and the second pixel electrode 132 connected to the central portion first switching element 12TX are electrically connected via the central portion first switching element 12TX at the timing at which the second period of the second input signal begins, and the first pixel electrode 131 connected to the frame-adjacent portion first switching elements 12TY and the second pixel electrode 132 connected to the frame-adjacent portion first switching elements 12TY are electrically connected via the frame-adjacent portion first switching elements 12TY later than the timing at which the second period of the second input signal begins.

In other words, the first input signal and the second input signal each undergo a repeated cycle of periods in the following order: a first period in which the signal is set more positive than the reference potential; a second period in which the signal is temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. The central portion first switching element 12TX is switched to the ON state at the timing at which the second period of the second input signal begins, and the frame-adjacent portion first switching elements 12TY are switched to the ON state later than the timing at which the second period of the second input signal begins (preferably, at the timing at which the second input signal reaches the reference potential).

A central portion first control signal which undergoes a repeated cycle of a first control period in which the signal is set to the first potential and a second control period in which the signal is set to the second potential lower than the first potential is input to the central portion first switching element 12TX. A frame-adjacent portion first control signal which undergoes a repeated cycle of a first control period in which the signal is set to the first potential and a second control period in which the signal is set to the second potential lower than the first potential is input to each frame-adjacent portion first switching element 12TY.

In other words, in FIG. 28, because the central portion of the second pixel electrode 132 is required to be charged at a high speed as indicated by the arrow for the central portion first control signal, the central portion first switching element 12TX is switched to the ON state simultaneously with the change in the second input signal. In contrast, the frame-adjacent portion first switching elements 12TY are switched to the ON state after the second input signal returns to the reference potential (0 V) as indicated by the arrow for the frame-adjacent portion first control signal in FIG. 28 so that the excessive potential change due to the overshoot does not affect the first pixel electrode 131.

This embodiment enables driving of the second pixel electrode 132 at a timing appropriate to the potential change in each region within the plane of the liquid crystal panel 11. This can reduce the difference in potential change between the central portion 11X and the frame-adjacent portions 11Y of the second pixel electrode 132 to effectively avoid a shift of the first pixel electrode 131 from the desired potential, thereby effectively improving the display quality.

The first potential of the central portion first control signal may be any potential that can switch the central portion first switching element 12TX to the ON state, and the second potential of the central portion first control signal may be any potential that can switch the central portion first switching element 12TX to the OFF state. In other words, the first control period of the central portion first control signal refers to a period in which the central portion first switching element 12TX is in the ON state, while the second control period of the central portion first control signal refers to a period in which the central portion first switching element 12TX is in the OFF state.

The first potential of the frame-adjacent portion first control signal may be any potential that can switch the frame-adjacent portion first switching elements 12TY to the ON state, and the second potential of the frame-adjacent portion first control signal may be any potential that can switch the frame-adjacent portion first switching elements 12TY to the OFF state. In other words, the first control period of the frame-adjacent portion first control signal refers to a period in which the frame-adjacent portion first switching elements 12TY are in the ON state, and the second control period of the frame-adjacent portion first control signal refers to a period in which the frame-adjacent portion first switching elements 12TY are in the OFF state.

The liquid crystal panel 11 includes a plurality of first gate lines 1G, and the first gate lines 1G include a central portion first gate line 1GX and frame-adjacent portion first gate lines 1GY. The liquid crystal panel 11 also includes a plurality of first gate electrodes 12G, and the first gate electrodes 12G include a central portion first gate electrode 12GX and frame-adjacent portion first gate electrodes 12GY. The central portion first gate electrode 12GX is part of the central portion first gate line 1GX. The frame-adjacent portion first gate electrodes 12GY are each part of the corresponding frame-adjacent portion first gate line 1GY.

The central portion first switching element 12TX includes the first semiconductor layer 12A electrically connected to the first pixel electrode 131 and the second pixel electrode 132, and the central portion first gate electrode 12GX overlapping with the first semiconductor layer 12A via the first insulating layer 121. The frame-adjacent portion first switching elements 12TY each include the first semiconductor layer 12A electrically connected to the first pixel electrode 131 and the second pixel electrode 132 and the corresponding frame-adjacent portion first gate electrode 12GY overlapping with the first semiconductor layer 12A via the first insulating layer 121.

Similarly, the liquid crystal panel 11 includes a plurality of second switching elements 23T arranged between the second pixel electrode 132 and the third pixel electrode 133, and the second switching elements 23T include a central portion second switching element 23TX arranged in the central portion of the liquid crystal panel 11 in the second direction and frame-adjacent portion second switching elements 23TY arranged in the frame-adjacent portions 11Y of the liquid crystal panel 11 in the second direction.

In the second period, the second input signal and the third input signal are temporarily set more negative than the reference potential and subsequently set to the reference potential, the second pixel electrode 132 connected to the central portion second switching element 23TX and the third pixel electrode 133 connected to the central portion second switching element 23TX are electrically connected via the central portion second switching element 23TX at the timing at which the second period of the third input signal begins, and the second pixel electrode 132 connected to the frame-adjacent portion second switching elements 23TY and the third pixel electrode 133 connected to the frame-adjacent portion second switching elements 23TY are electrically connected via the frame-adjacent portion second switching elements 23TY later than the timing at which the second period of the third input signal begins.

In other words, the second input signal and the third input signal each undergo a repeated cycle of periods in the following order: a first period in which the signal is set more positive than the reference potential; a second period in which the signal is temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. The central portion second switching element 23TX is switched to the ON state at the timing at which the second period of the third input signal begins, and the frame-adjacent portion second switching elements 23TY are switched to the ON state later than the timing at which the second period of the third input signal begins (preferably, at the timing at which the third input signal reaches the reference potential (0 V)).

A central portion second control signal which undergoes a repeated cycle of a first control period in which the signal is set to the first potential and a second control period in which the signal is set to the second potential lower than the first potential is input to the central portion second switching element 23TX. A frame-adjacent portion second control signal which undergoes a repeated cycle of a first control period in which the signal is set to the first potential and a second control period in which the signal is set to the second potential lower than the first potential is input to each frame-adjacent portion second switching element 23TY.

This embodiment enables driving of the third pixel electrode 133 at a timing appropriate to the potential change in each region within the plane of the liquid crystal panel 11. This can reduce the difference in potential change between the central portion 11X and the frame-adjacent portions 11Y of the third pixel electrode 133 to effectively avoid a shift of the second pixel electrode 132 from the desired potential, thereby effectively improving the display quality.

The first potential of the central portion second control signal may be any potential that can switch the central portion second switching element 23TX to the ON state, and the second potential of the central portion second control signal may be any potential that can switch the central portion second switching element 23TX to the OFF state. In other words, the first control period of the central portion second control signal refers to a period in which the central portion second switching element 23TX is in the ON state, while the second control period of the central portion second control signal refers to a period in which the central portion second switching element 23TX is in the OFF state.

The first potential of the frame-adjacent portion second control signal may be any potential that can switch the frame-adjacent portion second switching elements 23TY to the ON state, and the second potential of the frame-adjacent portion second control signal may be any potential that can switch the frame-adjacent portion second switching element 23TY to the OFF state. In other words, the first control period of the frame-adjacent portion second control signal refers to a period in which the frame-adjacent portion second switching elements 23TY are in the ON state, and the second control period of the frame-adjacent portion second control signal refers to a period in which the frame-adjacent portion second switching elements 23TY are in the OFF state.

The liquid crystal panel 11 includes a plurality of second gate lines 2G, and the second gate lines 2G include a central portion second gate line 2GX and frame-adjacent portion second gate lines 2GY. The liquid crystal panel 11 also includes a plurality of second gate electrodes 23G, and the second gate electrodes 23G include a central portion second gate electrode and frame-adjacent portion second gate electrodes. The central portion second gate electrode is part of the central portion second gate line 2GX. The frame-adjacent portion second gate electrodes are each part of the corresponding frame-adjacent portion second gate line 2GY.

The central portion second switching element 23TX includes the second semiconductor layer 23A electrically connected to the second pixel electrode 132 and the third pixel electrode 133, and the central portion second gate electrode overlapping with the second semiconductor layer 23A via the first insulating layer 121. The frame-adjacent portion second switching elements 23TY each include the second semiconductor layer 23A electrically connected to the second pixel electrode 132 and the third pixel electrode 133, and the corresponding frame-adjacent portion second gate electrode overlapping with the second semiconductor layer 23A via the first insulating layer 121.

Similarly, the liquid crystal panel 11 includes a plurality of third switching elements 34T arranged between the third pixel electrode 133 and the fourth pixel electrode 134, and the third switching elements 34T include a central portion third switching element 34TX arranged in the central portion of the liquid crystal panel 11 in the second direction and frame-adjacent portion third switching elements 34TY arranged in the frame-adjacent portions 11Y of the liquid crystal panel 11 in the second direction.

In the third period, the third input signal and the fourth input signal are temporarily set more negative than the reference potential and subsequently set to the reference potential, the third pixel electrode 133 connected to the central portion third switching element 34TX and the fourth pixel electrode 134 connected to the central portion third switching element 34TX are electrically connected via the central portion third switching element 34TX at the timing at which the second period of the fourth input signal begins, and the third pixel electrode 133 connected to the frame-adjacent portion third switching elements 34TY and the fourth pixel electrode 134 connected to the frame-adjacent portion third switching elements 34TY are electrically connected via the frame-adjacent portion third switching elements 34TY later than the timing at which the second period of the fourth input signal begins.

In other words, the third input signal and the fourth input signal each undergo a repeated cycle of periods in the following order: a first period in which the signal is set more positive than the reference potential; a second period in which the signal is temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential. The central portion third switching element 34TX is switched to the ON state at the timing at which the second period of the fourth input signal begins, and the frame-adjacent portion third switching elements 34TY are switched to the ON state later than the timing at which the second period of the fourth input signal begins (preferably, at the timing at which the fourth input signal reaches the reference potential (0 V)).

A central portion third control signal which undergoes a repeated cycle of a first control period in which the signal is set to the first potential and a second control period in which the signal is set to the second potential lower than the first potential is input to the central portion third switching element 34TX. A frame-adjacent portion third control signal which undergoes a repeated cycle of a first control period in which the signal is set to the first potential and a second control period in which the signal is set to the second potential lower than the first potential is input to each frame-adjacent portion third switching element 34TY.

This embodiment enables driving of the fourth pixel electrode 134 at a timing appropriate to the potential change in each region within the plane of the liquid crystal panel 11. This can reduce the difference in potential change between the central portion 11X and the frame-adjacent portions 11Y of the fourth pixel electrode 134 to effectively avoid a shift of the third pixel electrode 133 from the desired potential, thereby effectively improving the display quality.

The first potential of the central portion third control signal may be any potential that can switch the central portion third switching element 34TX to the ON state, and the second potential of the central portion third control signal may be any potential that can switch the central portion third switching element 34TX to the OFF state. In other words, the first control period of the central portion third control signal refers to a period in which the central portion third switching element 34TX is in the ON state, while the second control period of the central portion third control signal refers to a period in which the central portion third switching element 34TX is in the OFF state.

The first potential of the frame-adjacent portion third control signal may be any potential that can switch the frame-adjacent portion third switching elements 34TY to the ON state, and the second potential of the frame-adjacent portion third control signal may be any potential that can switch the frame-adjacent portion third switching elements 34TY to the OFF state. In other words, the first control period of the frame-adjacent portion third control signal refers to a period in which the frame-adjacent portion third switching elements 34TY are in the ON state, and the second control period of the frame-adjacent portion third control signal refers to a period in which the frame-adjacent portion third switching elements 34TY are in the OFF state.

The liquid crystal panel 11 includes a plurality of third gate lines 3G, and the third gate lines 3G include a central portion third gate line 3GX and frame-adjacent portion third gate lines 3GY. The liquid crystal panel 11 also includes a plurality of third gate electrodes 34G, and the third gate electrodes 34G include a central portion third gate electrode and frame-adjacent portion third gate electrodes. The central portion third gate electrode is part of the central portion third gate line 3GX. The frame-adjacent portion third gate electrodes are each part of the corresponding frame-adjacent portion third gate line 3GY.

The central portion third switching element 34TX includes the third semiconductor layer 34A electrically connected to the third pixel electrode 133 and the fourth pixel electrode 134, and the central portion third gate electrode overlapping with the third semiconductor layer 34A via the first insulating layer 121. The frame-adjacent portion third switching elements 34TY each include the third semiconductor layer 34A electrically connected to the third pixel electrode 133 and the fourth pixel electrode 134, and the corresponding frame-adjacent portion third gate electrode overlapping with the third semiconductor layer 34A via the first insulating layer 121.

### Modified Example of Embodiments 1 to 5

Although examples are described in which the first electrode and the second electrode are the pixel electrodes 130 in Embodiments 1 to 5, the first electrode and the second electrode may each be the common electrode 230. In other words, the first pixel electrode 131 corresponds to a first common electrode and the second pixel electrode 132 corresponds to a second common electrode. This embodiment can also reduce or prevent signal delays.

In the present modified example, the frame lines 100NL are common signal lines, for example.

The first substrate 100 includes, sequentially toward the liquid crystal layer 300:
the first support substrate 110; the first semiconductor layer 12A; the first insulating layer 121; the first gate electrodes 12G; the second insulating layer 122; the first metal portion 12B connected to the first common electrode and the first semiconductor layer 12A and the second metal portion 12C connected to the second common electrode and the first semiconductor layer 12A; the third insulating layer 123; and the first common electrode and the second common electrode.

The second substrate 200 includes, sequentially toward the liquid crystal layer 300, the second support substrate 210, the insulating layer 220, and the pixel electrodes 130. The pixel electrodes 130 are each electrically connected to the corresponding segment signal line in the liquid crystal panel 11.

Although the pixel electrodes 130 are arranged in the second substrate 200 in the present embodiment, the pixel electrodes 130 may be arranged in the first substrate 100.

### EXAMPLES

Hereinbelow, the effect of the present invention is described with reference to examples. However, the present invention is not limited to these examples.

### Example 1

A liquid crystal panel 11 of Example 1 corresponds to the liquid crystal panel 11 of Embodiment 1. The reference potential was set to 0 V. The liquid crystal panel 11 of the present example includes the pixel electrodes (segments) 130, the common (COM) electrode 230, and the liquid crystal layer 300, and is a panel (active retarder) which actively controls the alignment of the liquid crystal layer 300 in response to the voltage applied between the pixel electrodes 130 and the common electrode 230. The pixel electrodes 130 are formed of a transparent electrode within the display region 1AA. In the frame region 1NA, bus lines (specifically, segment signal lines) formed of a low-resistant metal layer are arranged as the frame lines 100NL. Each pixel electrode 130 is connected to the corresponding bus line formed of a metal layer in the frame region 1NA.

The liquid crystal panel 11 of the present example is suitable when there are pixel electrodes 130 (in FIG. 2, the second pixel electrode 132 and the third pixel electrode 133) with fewer connection sides with the frame lines 100NL arranged in the frame region 1NA, particularly due to the number of pixel electrodes 130.

At the boundary between vertically adjacent pixel electrodes 130, the switching elements 10T that connect these pixel electrodes 130 are arranged. The switching elements 10T are controlled by control signals (first control signal input to the first gate electrodes 12G, a second control signal input to the second gate electrodes 23G, and a third control signal input to the third gate electrodes 34G).

Although the configuration at the boundary between the first pixel electrode 131 and the second pixel electrode 132 is shown as an example, a similar configuration is employed at the boundaries between other adjacent pixel electrodes 130. As shown in FIG. 5, an input signal that undergoes a repeated cycle of application of voltage with a positive polarity→no voltage application→application of voltage with a negative polarity→no voltage application→application of voltage with a positive polarity is input to each pixel electrode 130. The phase delay of input signals increase in the order of the first pixel electrode 131, the second pixel electrode 132, the third pixel electrode 133, and the fourth pixel electrode 134. The write voltages of positive polarity and negative polarity in each input signal are binary only, with no intermediate level present.

As shown in FIG. 5, the switching element 12T is switched to the ON state at the timing at which the input signals to the first pixel electrode 131 and the second pixel electrode 132 exhibit the same potential (in the period indicated by the dashed and dotted line arrows in FIG. 5), so that the first pixel electrode 131 and the second pixel electrode 132 are electrically connected via the switching element 12T.

Since the first pixel electrode 131 is connected to the frame lines 100NL (bus lines) arranged in the frame region 1NA along three sides and can be rapidly charged, the first pixel electrode 131 is already charged to the desired potential at the timing at which the first control period of the first control signal begins (i.e., the timing at which the first period of the second input signal begins (the timing at which the charging of the second pixel electrode 132 begins)).

The first semiconductor layer 12A, the second semiconductor layer 23A, and the third semiconductor layer 34A in the liquid crystal panel 11 of the present example are IGZO layers and are of the n-type. The drive voltage for the segment signal is about ±10 to ±20 V, and the drive voltage for the control signal is about ±15 to ±25 V.

### Comparative Example 1

A liquid crystal panel of Comparative Example 1 is similar to the liquid crystal panel of Example 1, except that the first pixel electrode 131 and the second pixel electrode 132 are not connected by any switching element, the second pixel electrode 132 and the third pixel electrode 133 are not connected by any switching element, and the third pixel electrode 133 and the fourth pixel electrode 134 are not connected by any switching element.

### Comparison between Example 1 and Comparative Example 1

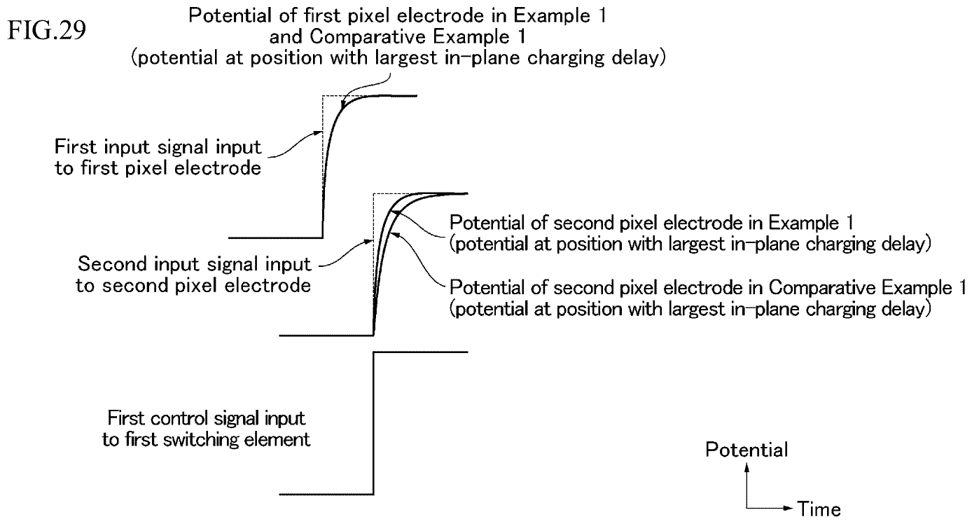

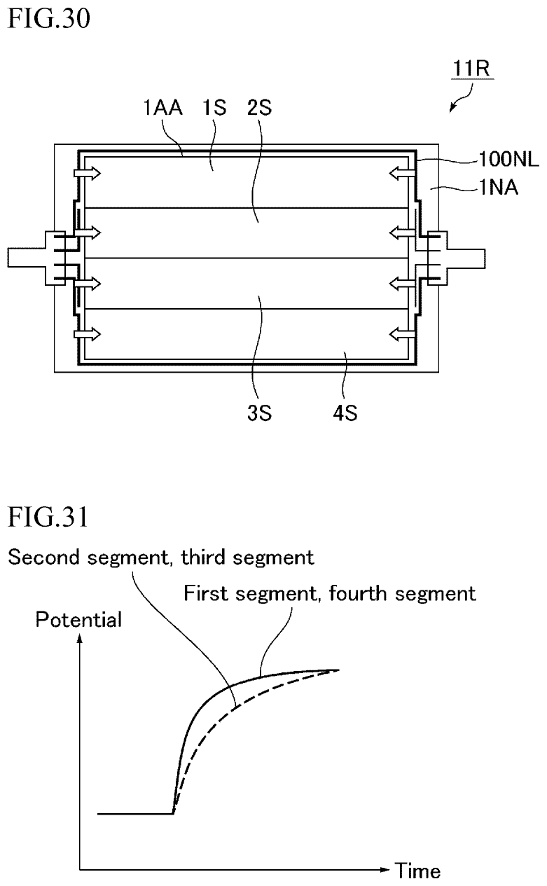

FIG. 29 is a timing diagram of the time-dependent potential changes of the first pixel electrode and the second pixel electrode in the liquid crystal panels of Example 1 and Comparative Example 1, and a first control signal. When a positive polarity is written in each of the liquid crystal panels of Example 1 and Comparative Example 1 in the state with no voltage applied as shown in FIG. 29, the signal delay to the second pixel electrode in the liquid crystal panel of Comparative Example 1 is large. However, the signal delay to the second pixel electrode 132 is reduced in the liquid crystal panel 11 of Example 1. This is seemingly owing to the signal input from the first pixel electrode 131 to the second pixel electrode 132 in the liquid crystal panel 11 of Example 1.

### Example 2

A liquid crystal panel 11 of Example 2 corresponds to the liquid crystal panel 11 of Embodiment 2. The reference potential was set to 0 V. In the liquid crystal panel 11 of Example 1, the timing at which the switching element 12T is switched to the ON state coincides with the timing at which the charging of the second pixel electrode 132 begins. However, in the liquid crystal panel 11 of the present example, the timing at which the switching element 12T is switched to the ON state is later than the timing at which the charging of the second pixel electrode 132 begins. Therefore, in the liquid crystal panel 11 of Example 2, the potential drop of the first pixel electrode 131 which possibly occurs in the liquid crystal panel 11 of Example 1 can be reduced or prevented.

### Example 3

A liquid crystal panel 11 of Example 3 corresponds to the liquid crystal panel 11 of Embodiment 3. The reference potential was set to 0 V. Although the voltage range for the first control signal is set to ±25 V in the liquid crystal panel 11 of Example 1, the voltage range for the first control signal is set to −25 V to +10 V in the liquid crystal panel 11 of Example 3.

In the liquid crystal panel 11 of Example 3, the frequency of the control signal can be half of that in Example 1. In other words, the power consumption of a control signal in Example 3 can be half of the corresponding control signal in Example 1.

Additionally, in Example 1, the potential of the first control signal is required to be about +25 V in order to charge the first pixel electrode 131 and the second pixel electrode 132 to +20 V. However, in Example 3, it suffices as long as the first pixel electrode 131 and the second pixel electrode 132 can be set in the state with no voltage applied (=0 V), so that a potential of the first control signal set to about +5 V would be sufficient.

### Example 4

A liquid crystal panel 11 of Example 4 corresponds to the liquid crystal panel 11 of Embodiment 4. In the liquid crystal panel 11 of Example 1, a plurality of switching elements 12T are arranged across the entire lateral region of the liquid crystal panel 11. However, in the liquid crystal panel 11 of the present example, one or more switching elements 12T are arranged in the central portion 11X of the liquid crystal panel 11 in the second direction, and are not arranged in the frame-adjacent portions 11Y of the liquid crystal panel 11 in the second direction. This embodiment can reduce or prevent the influence of the second pixel electrode 132 with an excessive potential change on the already charged first pixel electrode 131 in the frame-adjacent portions 11Y. As a result, a shift of the potential of the first pixel electrode 131 from the desired potential can be avoided, thereby improving the display quality.

### Example 5

A liquid crystal panel 11 of Example 5 corresponds to the liquid crystal panel 11 of Embodiment 5. In the liquid crystal panel 11 of Example 4, the switching elements 12T are arranged in the central portion 11X of the liquid crystal panel 11 in the second direction and are not arranged in the frame-adjacent portions 11Y of the liquid crystal panel 11 in the second direction. However, in the liquid crystal panel 11 of the present example, the central portion first switching element 12TX is arranged in the central portion 11X of the liquid crystal panel 11 in the second direction and the frame-adjacent portion first switching elements 12TY different from the central portion first switching element 12TX are arranged in the frame-adjacent portions 11Y of the liquid crystal panel 11 in the second direction. Additionally, the central portion first switching element 12TX is switched to the ON state at the timing at which the second period of the second input signal begins, and the frame-adjacent portion first switching elements 12TY are switched to the ON state later than the timing at which the second period of the second input signal begins (preferably, the timing at which the second input signal reaches 0 V). This embodiment enables driving of the second pixel electrode 132 at a timing appropriate to the potential change in each region within the plane of the liquid crystal panel 11. This can effectively avoid a shift of the first pixel electrode 131 from the desired potential, thereby effectively improving the display quality.

What is claimed is:

1. A liquid crystal panel with a display region and a frame region surrounding the display region, the liquid crystal panel comprising:
a first substrate;
a second substrate facing the first substrate; and
a liquid crystal layer arranged between the first substrate and the second substrate,
wherein the first substrate or the second substrate includes a frame line arranged in the frame region,
the first substrate includes, within the display region, a first electrode and a second electrode electrically connected to the frame line, and a switching element configured to control electrical connection between the first electrode and the second electrode,
a first input signal is input to the first electrode, and a second input signal is input to the second electrode,
the first input signal and the second input signal each undergo a repeated cycle of periods in the following order: a first period in which the signal is set more positive than a reference potential; a second period in which the signal is set to the reference potential or temporarily set more negative than the reference potential and subsequently set to the reference potential; a third period in which the signal is set more negative than the reference potential; and a fourth period in which the signal is set to the reference potential or temporarily set more positive than the reference potential and subsequently set to the reference potential,
the first period, the second period, the third period, and the fourth period of the first input signal overlap with and begin at timings earlier than the first period, the second period, the third period, and the fourth period of the second input signal, respectively, and
the first electrode is electrically connected to the second electrode via the switching element in a period from a beginning of the second period of the second input signal to an end of the second period of the first input signal and in a period from a beginning of the fourth period of the second input signal to an end of the fourth period of the first input signal.

2. The liquid crystal panel according to claim 1,
wherein the first electrode is electrically connected to the second electrode via the switching element in a period from a beginning of the first period of the second input signal to an end of the first period of the first input signal and in a period from a beginning of the third period of the second input signal to an end of the third period of the first input signal.

3. The liquid crystal panel according to claim 1,
wherein a timing at which the first electrode is electrically connected to the second electrode via the switching element is later than a timing at which the first period of the second input signal begins.

4. The liquid crystal panel according to claim 1,
wherein the first electrode is not electrically connected to the second electrode in a period from a beginning of the first period of the second input signal to an end of the first period of the first input signal and in a period from a beginning of the third period of the second input signal to an end of the third period of the first input signal.

5. The liquid crystal panel according to claim 1,
wherein the first electrode and the second electrode are arranged along a first direction of the liquid crystal panel and extend along a second direction perpendicular to the first direction.

6. The liquid crystal panel according to claim 5,
wherein the liquid crystal panel includes a plurality of switching elements, each being identical to the switching element, and
the plurality of switching elements are arranged from one end portion to an other end portion of the liquid crystal panel in the second direction.

7. The liquid crystal panel according to claim 5,
wherein the liquid crystal panel includes one or more switching elements, each being identical to the switching element, and
the one or more switching elements are arranged in a central portion of the liquid crystal panel in the second direction, and are not arranged in a frame-adjacent portion of the liquid crystal panel in the second direction.

8. The liquid crystal panel according to claim 5,
wherein the liquid crystal panel includes a plurality of switching elements, each being identical to the switching element, and
the plurality of switching elements include a central portion switching element arranged in a central portion of the liquid crystal panel in the second direction and a frame-adjacent portion switching element arranged in a frame-adjacent portion of the liquid crystal panel in the second direction.

9. The liquid crystal panel according to claim 8,
wherein in the second period, the first input signal and the second input signal are temporarily set more negative than the reference potential and subsequently set to the reference potential,
the first electrode connected to the central portion switching element and the second electrode connected to the central portion switching element are electrically connected via the central portion switching element at a timing at which the second period of the second input signal begins, and
the first electrode connected to the frame-adjacent portion switching element and the second electrode connected to the frame-adjacent portion switching element are electrically connected via the frame-adjacent portion switching element later than the timing at which the second period of the second input signal begins.

10. The liquid crystal panel according to claim 1,
wherein the switching element is controlled by a control signal that is different from the first input signal and the second input signal.

11. The liquid crystal panel according to claim 1,
wherein in a plan view, an edge of the first electrode facing the frame region is longer than an edge of the second electrode facing the frame region.

12. A display device comprising:
the liquid crystal panel according to claim 1;
an image display panel disposed adjacent to a back surface of the liquid crystal panel; and
a backlight disposed adjacent to a back surface of the image display panel.
